(19) United States
(12) Patent Application Publication
(10) Pub. No.: US 2016/0180435 A1
(43) Pub. Date: Jun. 23, 2016

(54) SEARCH DEVICE, PROGRAM, RECORDING MEDIUM, AND METHOD

(71) Applicant: Rakuten, Inc., Tokyo (JP)

(72) Inventor: Takayuki OURA, Tokyo (JP)

(73) Assignee: Rakuten, Inc., Tokyo (JP)

(21) Appl. No.: 14/911,049

(22) PCT Filed: Sep. 27, 2013
(86) PCT No.: PCT/JP2013/076391

§ 371 Date: Feb. 9, 2016

(51) Int. Cl. G06Q 30/06

(52) U.S. Cl. CPC G06Q 30/0627

(57) ABSTRACT

A search device comprises a search range acquirer to acquire a search range in which a search condition of a product is classified; a sale product searcher to search for a product sold under a condition classified into a range matching the acquired search range; a promotional product searcher to search a group of promotional products undergoing sales promotion for a product sold under a condition classified into a range that does not match the search range but of which a difference from the search range is equal to or smaller than a given difference; and an outputter to output a webpage posting a found sale product that is the product found by the sale product searcher and a found promotional product that is the promotional product found by the promotional product searcher, or outputting a webpage positing the found sale product and a webpage posting the found promotional product.

### TECHNICAL FIELD

The present disclosure relates to a search device, program, non-transitory recording medium, and method.

### BACKGROUND ART

Information provision devices not displaying advertisements of products not meeting search conditions such as those out of stock and displaying only advertisements of products meeting search conditions are known in the prior art (for example, Patent Literature 1).

### CITATION LIST

### Patent Literature

Patent Literature 1: Unexamined Japanese Patent Application Kokai Publication No. 2009-003840.

### SUMMARY OF INVENTION

### Technical Problem

Generally, conditions for displaying an advertisement of a product are often determined according to the contract or the like regardless of search conditions. Therefore, an advertisement of a product not meeting the search conditions has to be displayed in some cases. The information provision device of the Patent Literature 1 does not display an advertisement of a product not meeting the search conditions; thus, the contract is not fulfilled and the sponsor is not fully satisfied in some cases.

On the other hand, if advertisements of products irrelevant to the search conditions are displayed, the user has to select one meeting the search conditions or one that is different from the search conditions but of which the difference is acceptable from among many displayed advertisements, which impairs the convenience to the user.

Therefore, the information provision device of the Patent Literature 1 has the problem of failing sales promotion of a product different from the search conditions with less impaired convenience to the user.

The present disclosure is made with the view of the above problem and an objective of the disclosure is to provide a search device, program, non-transitory recording medium, and method capable of outputting information promoting sales of products different from the search conditions with less impaired convenience to the user.

### Solution to Problem

In order to achieve the above objective, the search device according to a first exemplary aspect of the present disclosure is a search device for searching for a product, comprising:

search range acquirer to acquire a search range in which a search condition of a product is classified;

sale product searcher to search for a product sold under a condition classified into a range matching the acquired search range;

promotional product searcher to search a group of promotional products undergoing sales promotion for a product sold under a condition classified into a range that does not match the search range but of which a difference from the search range is equal to or smaller than a given difference; and

outputter to output a webpage posting a found sale product that is the product found by the sale product searcher and a found promotional product that is the promotional product found by the promotional product searcher, or outputting a webpage positing the found sale product and a webpage posting the found promotional product.

Moreover, it is possible in the search device according to the first exemplary aspect that:

the webpage posting the found sale product and the found promotional product and the webpage posting the found promotional product post promotion information including the sales condition of the found promotional product and promoting the sale of the found promotional product.

Moreover, it is possible in the search device according to the first exemplary aspect that:

the webpage posting the found sale product and the found promotional product and the webpage posting the found promotional product each post an advertisement of the found promotional product as the promotion information.

Moreover, it is possible in the search device according to the first exemplary aspect that:

the search condition includes a period-of-use specification condition specifying a time period in which the searched product is used,

the webpage posting the found promotional product includes one or more display items presenting a difference between a time period in which the found promotional product is used and the time period specified by the period-of-use specification condition, and

the one or multiple display items presenting the difference are associated with a webpage used for purchasing the found promotional product sold under the condition having the difference.

Moreover, it is possible in the search device according to the first exemplary aspect that:

the search condition includes a period-of-use specification condition specifying a time period in which the searched product is used,

the webpage posting the found promotional product includes one or more display items presenting a difference between a time period in which the found promotional product is used and the time period specified by the period-of-use specification condition, and

the one or multiple display items presenting the difference are associated with a webpage used for adding a condition to the sales condition of the found promotional product having the difference.

Moreover, it is possible in the search device according to the first exemplary aspect that:

the search condition of a product includes a start date/time specification condition specifying a date/time when the user purchasing the product starts using the product and a start place specification condition specifying a place where the user starts using the product,

travelling time calculator to calculate the traveling time required for the user to travel from a place where use of the promotional product ends to the place specified by the start place specification condition is further provided, and

the promotional product searcher searches promotional products sold under a condition classified into a range not matching the search range for a product sold under the condition that the use ends at a place different from the place specified by the start place specification condition and under the condition that the use ends at a date/time prior to the date/time specified by the start date/time specification condition by more than or equal to the travelling time as the product sold under the condition classified into the range of which difference from the search range is equal to or smaller than the given difference.

Moreover, it is possible in the search device according to the first exemplary aspect that:

the search condition of a product includes an end date/time specification condition specifying a date/time when the user having purchased the product ends using the product and an end place specification condition specifying a place where the user ends use of the product,

travelling time calculator to calculate the traveling time required for the user to travel from the place specified by the end place specification condition to a place where use of the promotional product starts is further provided, and

the promotional product searcher searches promotional products sold under a condition classified into a range not matching the search range for a product sold under the condition that the use starts at a place different from the place specified by the end place specification condition and under the condition that the use starts at a date/time posterior to the date/time specified by the end date/time specification condition by more than or equal to the travelling time as the product sold under the condition classified into the range of which difference from the search range is equal to or smaller than the given difference.

Moreover, it is possible that the search device according to the first exemplary aspect further comprises:

request acquirer to acquire a sales request with the promotional product;

acceptability calculator to calculate the acceptability presenting how easy for the user to accept a difference between the range into which the sales condition of the promotional product is classified and the search range based on a difference in price between the promotional product sold in response to the sales request and the sale product; and

saver to save the calculated acceptability in a storage in association with the range into which the sales condition of the promotional product is classified and the search range,

wherein the promotional product searcher searches the group of products for a promotional product using the range associated with the acceptability higher than a given threshold and the search range as the range of which the difference from the search range is equal to or smaller than the given difference.

In order to achieve the above objective, the program according to a second exemplary aspect of the present disclosure is a program for searching for a product, allowing a computer to function as:

search range acquirer to acquire a search range in which the search conditions of a product is classified;

sale product searcher to search for a product sold under a condition classified into the range matching the acquired search range;

promotional product searcher to search a group of promotional products undergoing sales promotion for a product sold under a condition classified into a range that does not match the search range but of which a difference from the search range is equal to or smaller than a given difference; and

outputter to output a webpage posting a found sale product that is a product found by the sale product searcher and a found promotional product that is a promotional product found by the promotional product searcher, or outputting a webpage positing the found sale product and a webpage posting the found promotional product.

In order to achieve the above objective, the computer-readable non-transitory recording medium according to a third exemplary aspect of the present disclosure records a program for searching for a product, allowing a computer to function as:

search range acquirer to acquire a search range in which the search conditions of a product is classified;

sale product searcher to search for a product sold under a condition classified into the range matching the acquired search range;

promotional product searcher to search a group of promotional products undergoing sales promotion for a product sold under a condition classified into a range that does not match the search range but of which a difference from the search range is equal to or smaller than a given difference; and

outputter to output a webpage posting a found sale product that is a product found by the sale product searcher and a found promotional product that is a promotional product found by the promotional product searcher, or outputting a webpage positing the found sale product and a webpage posting the found promotional product.

In order to achieve the above objective, the method according to a fourth exemplary aspect of the present disclosure is a method for searching for a product, comprising:

a search range acquisition step of acquiring a search range in which the search conditions of a product is classified;

a sale product search step of searching for a product sold under a condition classified into the range matching the acquired search range;

a promotional product search step of searching a group of promotional products undergoing sales promotion for a product sold under a condition classified into a range that does not match the search range but of which a difference from the search range is equal to or smaller than a given difference; and

an output step of outputting a webpage posting a found sale product that is a product found in the sale product search step and a found promotional product that is a promotional product found in the promotional product search step, or outputting a webpage positing the found sale product and a webpage posting the found promotional product.

### Advantageous Effects of Invention

The search device, program, non-transitory recording medium, and method according to the present disclosure can output information promoting sales of products not meeting the search condition with less impaired convenience to the user.

### BRIEF DESCRIPTION OF DRAWINGS

FIG. 1 is a system configuration diagram presenting an exemplary search system;

FIG. 2A is an illustration presenting an example of the search condition input screen;

FIG. 2B is an illustration presenting an example of the search range input screen;

FIG. 3 is an illustration presenting an example of the search results output screen;

FIG. 4 is a hardware configuration diagram presenting an example of the search device;

FIG. 5 is a flowchart presenting an example of the search procedure executed by the search device according to Embodiment 1;

FIG. 6 is a functional block diagram presenting exemplary functions of the search device according to Embodiment 1;

FIG. 7 is an illustration presenting an example of the area ranges table stored by the search device according to Embodiment 1;

FIG. 8 is an illustration presenting an example of the adjoining area ranges table stored by the search device according to Embodiment 1;

FIG. 9 is an illustration presenting an example of the time ranges table stored by the search device according to Embodiment 1;

FIG. 10 is an illustration presenting an example of the adjoining time ranges table stored by the search device according to Embodiment 1;

FIG. 11 is an illustration presenting an example of the sale products table stored by the search device according to Embodiment 1;

FIG. 12 is an illustration presenting an example of the promotional products table stored by the search device according to Embodiment 1;

FIG. 13 is an illustration presenting an example of the found promotional product display region in Modified Embodiment 4 of Embodiment 1;

FIG. 14 is an illustration presenting an example of the selection page created by the search device;

FIG. 15 is an illustration presenting an example of the addable sales conditions table stored by the search device;

FIG. 16 is an illustration presenting an example of the promotional products table stored by the search device according to Embodiment 2;

FIG. 17 is an illustration presenting an example of the stations table stored by the search device according to Embodiment 2;

FIG. 18 is a flowchart presenting an example of the search procedure executed by the search device according to Embodiment 2;

FIG. 19 is a functional block diagram presenting exemplary functions of the search device according to Embodiment 2;

FIG. 20 is an illustration presenting an example of the promotional products table stored by the search device according to a modified embodiment of Embodiment 2;

FIG. 21 is an illustration presenting an example of the promotional products table stored by the search device according to a modified embodiment of Embodiment 2;

FIG. 22 is a flowchart presenting an example of the search procedure executed by the search device according to a modified embodiment of Embodiment 2;

FIG. 23 is an illustration presenting an example of the promotional products table stored by the search device according to Embodiment 3;

FIG. 24 is an illustration presenting an example of the promotional products table stored by the search device according to Embodiment 3;

FIG. 25 is an illustration presenting an example of the acceptability table stored by the search device according to Embodiment 3;

FIG. 26 is a flowchart presenting an example of the search procedure executed by the search device according to Embodiment 3;

FIG. 27 is a flowchart presenting an example of the sales procedure executed by the search device according to Embodiment 3; and

FIG. 28 is a functional block diagram presenting exemplary functions of the search device according to Embodiment 3.

### DESCRIPTION OF EMBODIMENTS

Embodiments of the present disclosure will be described hereafter with reference to the drawings.

### Embodiment 1

A search system 1 according to Embodiment 1 of the present disclosure enters a search condition according to the user operation and searches for a product to be sold to the user based on the entered search condition. The products to be sold are classified into a group of products that are promoted to sell more to the user than the other group of products (the promotional products, hereafter) and a group of products that are not the promotional products (the sale products, hereafter).

This embodiment will be described using tickets as an exemplary product. However, in this specification, the product can be any trading object regardless of whether it can be distributed, substituted, or mass-produced. Moreover, the product does not need to be tangible and can be something intangible such as electricity. Furthermore, the product does not need to be a movable property and can be an immovable property such as apartments and land.

This embodiment will be described using train tickets as an exemplary product. The tickets can be automobile or airplane rickets. A train ticket is a ticket verifying that the holder has the right to receive a service of transportation by a train, which can be a trading object and thus is a product. In other words, a product can be something in writing verifying the right to receive a service or the possession of such a right as long as it can be a trading object.

Therefore, a product can be a hotel reservation ticket or restaurant reservation ticket. This is because a hotel reservation ticket is a ticket verifying that the holder has the right to be provided with accommodations called a hotel and a restaurant reservation ticket is a ticket verifying that the holder has the right to be provided with food and drink at a restaurant. The reservation tickets do not need to be always a printed matter and can be an electronic ticket such as an e-mail message and electronic file.

Here, the service is a labor or benefit intended for someone that can be a trading object by itself. This embodiment is described on the assumption that different train operations (in other words, in the event that any one of the departure date/time, departure place, destination, and train itself is different) are considered to be different services. However, this is not restrictive. It is possible to assume different services in the event that at least one or more of the operation and reserved seat are different.

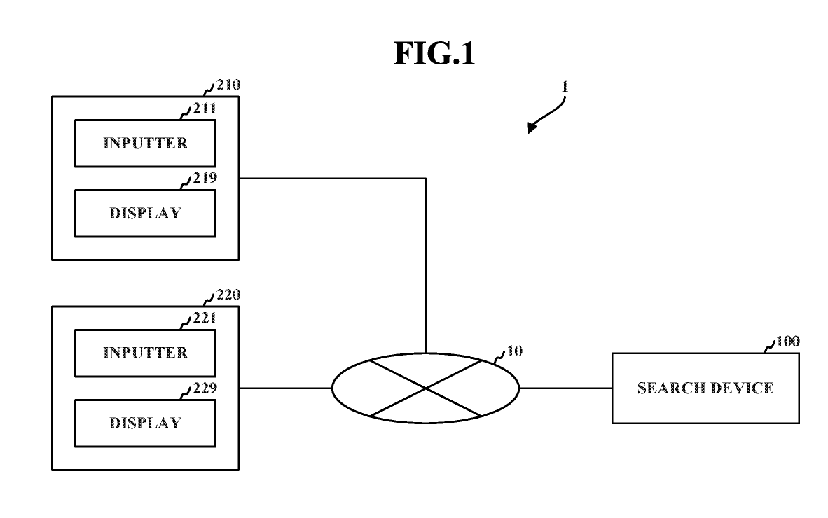

The search system 1 shown in FIG. 1 comprises a search device 100 and terminal devices 210 and 220, which are communicably connected to each other by a computer communication network 10 (simply the communication network 10, hereafter).

The communication network 10 is configured, for example, by the Internet. The communication network 10 can be a LAN (local area network) or public line network.

Prior to description of the search device 100, the terminal devices 210 and 220 will be described.

The terminal device 210 is configured, for example, by a personal computer comprising an inputter 211 such as a keyboard and mouse and a display 219 such as an LCD (liquid crystal display). The terminal device 220 comprises an inputter 221 and display 229 having the same configuration as the inputter 211 and display 219 of the terminal device 210.

The terminal devices 210 and 220 have the same configuration and execute the same operation. Therefore, the terminal device 210 will mainly be described hereafter.

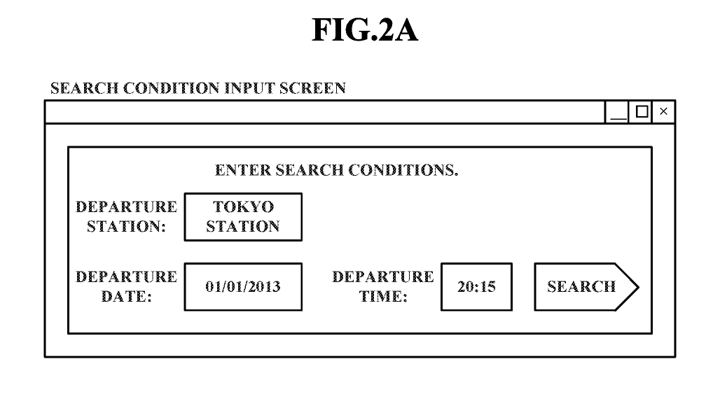

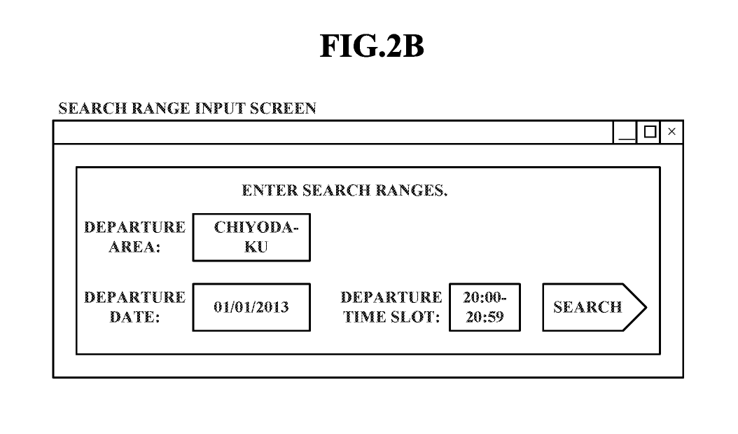

The terminal device 210 displays a search condition input screen used for searching for a product as shown in FIG. 2A. With the inputter 211 operated by the user, the terminal device 210 enters a product search condition according to the operation and sends to the search device 100 data presenting the entered search condition (the search condition data, hereafter).

This embodiment is described on the assumption that the search condition comprises a search station condition specifying a departure station, a search date condition specifying a departure date, and a search time condition specifying a departure time. Here, the explanation is made on the assumption that the search station condition specifying a departure station “TOKYO STATION”, the search date condition specifying a departure date “01/01/2013”, and the search time condition specifying a departure time “20:15” are entered as an example of the search condition.

The search device 100 classifies the search condition presented by the search condition data into a range into which one or multiple conditions are classified (the search range, hereafter). This is because the user does not always search for only a product sold under the condition completely matching the search condition. Then, the search device 100 searches for a range matching the search range and searches for a sale product sold under a condition classified into the found range.

Subsequently, the search device 100 searches for a range that does not match the search range but of which the difference from the search range is equal to or smaller than a given difference and searches for a promotional product sold under a condition classified into the found range. This is because in spite of a product sold under a condition not matching the search range, the user can easily recognize the difference if the product is sold under a condition classified into a range of which the difference from the search range is equal to or smaller than a given difference. The given difference will be described in detail later.

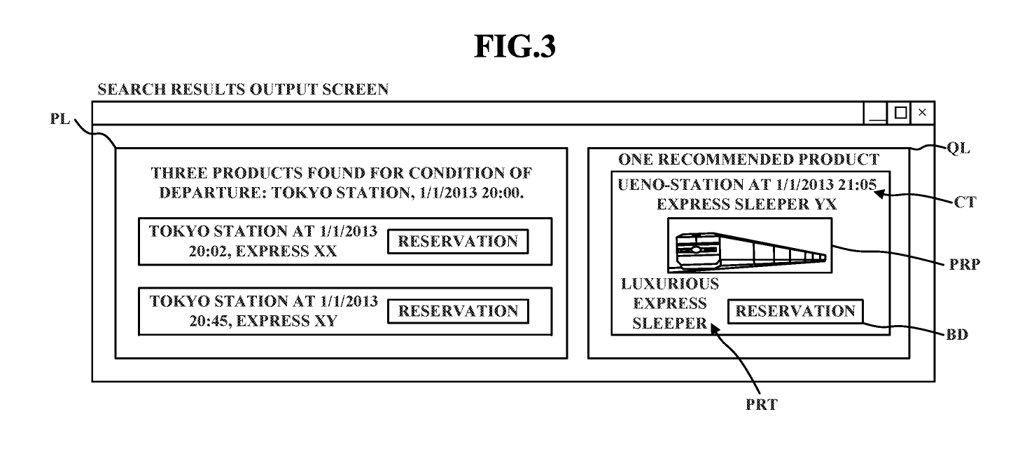

Then, the search device 100 creates a webpage of a search results output screen as shown in FIG. 3 posting the sale product that was found (the found sale product, hereafter) and the promotional product that was found (the found promotional product, hereafter), and returns the created webpage to the terminal device 210.

Subsequently, the terminal device 210 receives the webpage and displays the received webpage on the display 219.

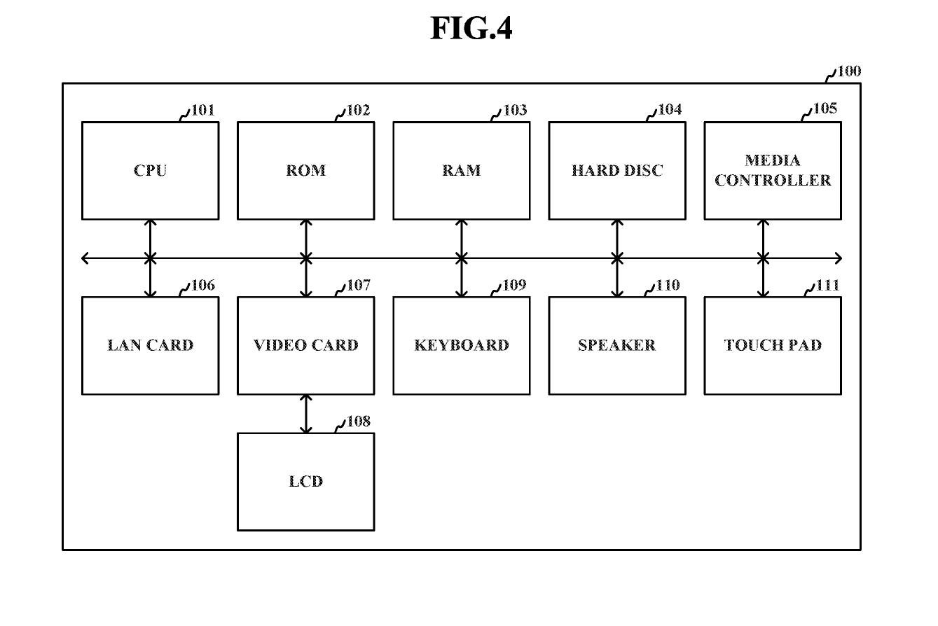

The search device 100 is configured by a server device as shown in FIG. 4. The search device 100 comprises a CPU (central processing unit) 101, a ROM (read only memory) 102, a RAM (random access memory) 103, a hard disc 104, a media controller 105, a LAN (local area network) card 106, a video card 107, an LCD (liquid crystal display) 108, a keyboard 109, a speaker 110, and a touch pad 111.

The CPU 101 executes programs according to programs stored in the ROM 102 or hard disc 104 to control the entire search device 100. The RAM 103 is the work memory temporarily storing data to process while the CPU 101 executes the programs.

The hard disc 104 is an information storage storing the tables saving various data. Moreover, the search device 100 can comprise a flash memory in place of the hard disc 104.

The media controller 105 reads various data and programs from non-transitory recording media including flash memory, CDs (compact discs), DVDs (digital versatile discs), and Blu-ray (registered trademark) discs.

The LAN card 106 transmits/receives data to/from the terminal devices 210 and 220 connected via the communication network 10. The keyboard 109 and touch pad 111 enter signals according to the user operation.

The video card 107 draws (namely renders) an image based on digital signals output from the CPU 101 and outputs image signals presenting the drawn image. The LCD 108 displays an image according to the image signals output from the video card 107. Moreover, the search device 100 can comprise a PDP (plasma display panel) or EL (electroluminescence) display in place of the LCD 108. The speaker 110 outputs sound based on signals output from the CPU 101.

The function of the search device 100 will be described hereafter.

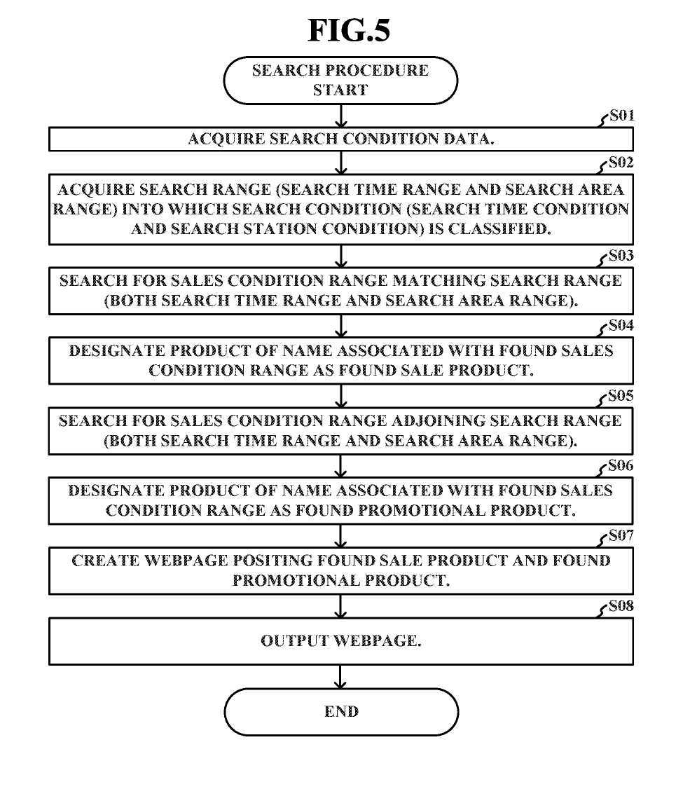

The CPU 101 executes the search procedure shown in FIG. 5. The search procedure is a procedure to search for a sale product and a promotional product based on the search condition presented by the search condition data sent from the terminal device 210.

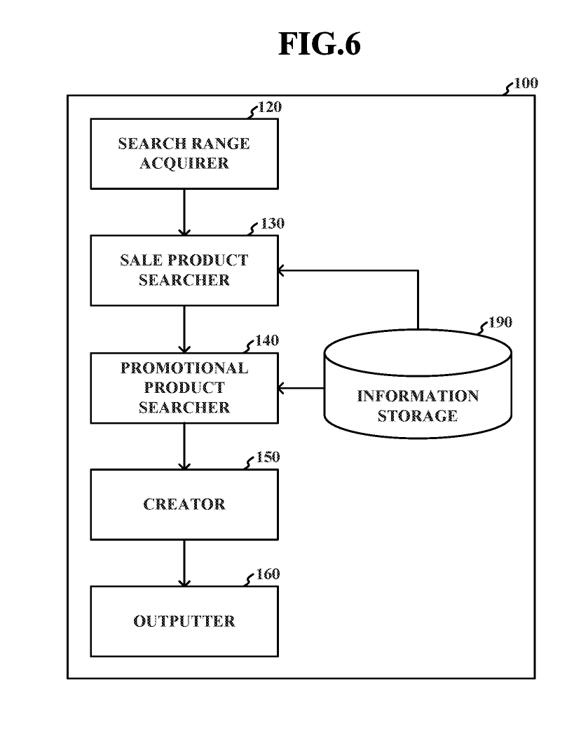

Executing this procedure, the CPU 101 functions as a search range acquirer 120, a sale product searcher 130, a promotional product searcher 140, a creator 150, and an outputter 160 shown in FIG. 6. Furthermore, the hard disc 104 shown in FIG. 4 functions as an information storage 190 in cooperation with the CPU 101.

Prior to description of the search range acquirer 120, sale product searcher 130, promotional product searcher 140, creator 150, and outputter 160, the information storage 190 will be described.

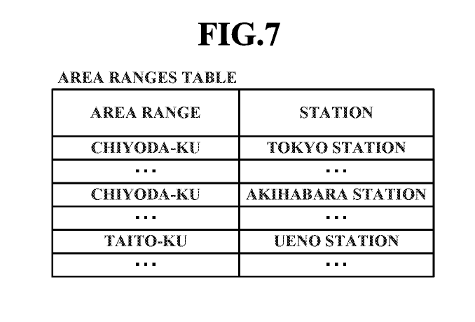

The information storage 190 stores an area ranges table as shown in FIG. 7. This is for the search device 100 to search for a train ticket of which the departure station is a station located in an area range matching the area range in which the station specified by the search condition is located (the search area range, hereafter).

Therefore, the area ranges table associates and saves multiple pieces of information presenting an area range and information presenting a station located in the area range. This embodiment is described on the assumption that the area ranges table associates and saves information presenting CHIYODA-KU (word) and information presenting TOKYO STATION and information presenting AKIHABARA STATION. This is because Tokyo Station and Akihabara Station are located in Chiyoda-ku. Furthermore, the explanation is made on the assumption that the area ranges table associates and saves information presenting TAITO-KU and information presenting UENO STATION. This is because Ueno Station is located in Taito-ku.

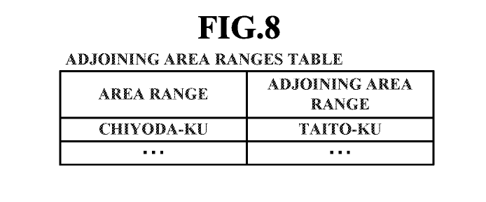

The information storage 190 stores an adjoining area ranges table as shown in FIG. 8. This is for the search device 100 to search the train tickets sold as promotional products for a train ticket of which the departure station is a station located in an area range adjoining the search area range (the adjoining area range of the search area range, hereafter) as a promotional product. This is because in spite of a train ticket of which the departure station is a station located in an area range different from the search area range, the user can easily recognize that the departure station is not located in the search area range if the departure station is located in an adjoining area range of the search area range.

Therefore, the adjoining area ranges table associates and saves multiple pieces of information presenting an area range and information presenting an area range adjoining the area range. This embodiment is described on the assumption that the area ranges table associates and saves information presenting CHIYODA-KU and information presenting TAITO-KU. This is because Chiyoda-ku and Taito-ku border each other.

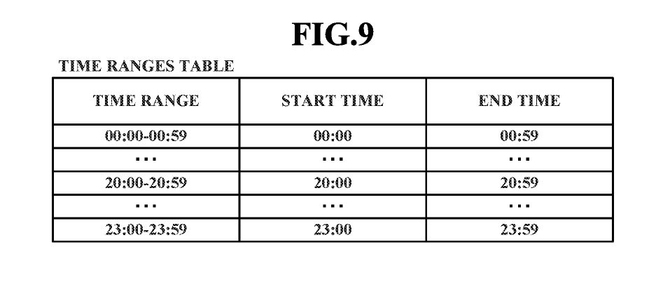

The information storage 190 stores a time ranges table as shown in FIG. 9. This is for the search device 100 to identify a time slot within which the departure time specified by the search condition falls (the search time range, hereafter) and search the tickets sold as sale products for a ticket for a train departing at a time classified into the range matching the search time range.

Therefore, the time ranges table associates and saves multiple pieces of information presenting a time range, information presenting the start time of the time range, and information presenting the end time of the time range.

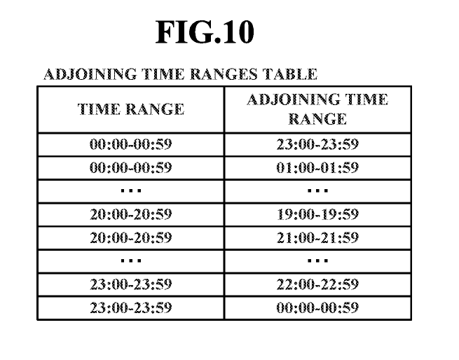

The information storage 190 stores an adjoining time ranges table as shown in FIG. 10. This is for the search device 100 to search the tickets sold as promotional products for a ticket for a train departing in a time range adjoining the search time range. This is because in spite of a ticket for a train departing in a time range different from the search time range, the user can easily accept the train not departing in the search time range if the train departs in a time range adjoining the search time range.

Therefore, the adjoining time ranges table associates and saves multiple pieces of information presenting a time range and information presenting a time range adjoining the time range.

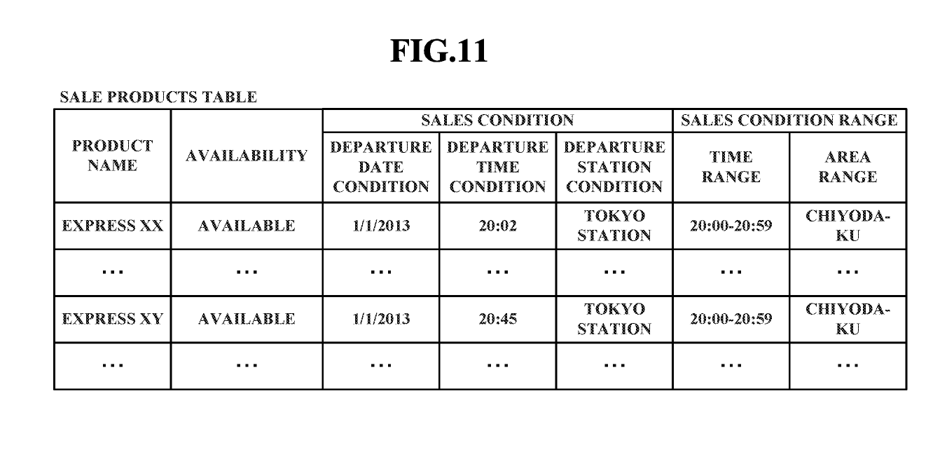

The information storage 190 stores a sale products table as shown in FIG. 11. The sale products table associates and saves multiple pieces of information presenting the name of a sale product, information presenting whether the sale product is available, information presenting the sales condition of the sale product, and information presenting the range into which the sales condition is classified (the sales condition range, hereafter).

A train ticket is generally sold with conditions specifying a train departing from a specific station at a specific time of a specific date for providing a transportation service by train. Therefore, the sales condition comprises a departure date condition specifying the departure date of a train, a departure time condition specifying the departure time of the train, and a departure station condition specifying the departure station of the train.

Furthermore, the train departure station is located in any one of the area ranges presented by the information saved in the area ranges table shown in FIG. 7. The departure time is included in any one of the time ranges presented by the information saved in the time ranges table shown in FIG. 9. Therefore, the time range including the time specified by the departure time condition constituting the sales condition is referred to as the sales condition time range. The area range in which the station specified by the departure station condition constituting the sales condition is referred to as the sales condition area range. The sales condition range into which the sales condition is classified comprises the sales condition time range and sales condition area range.

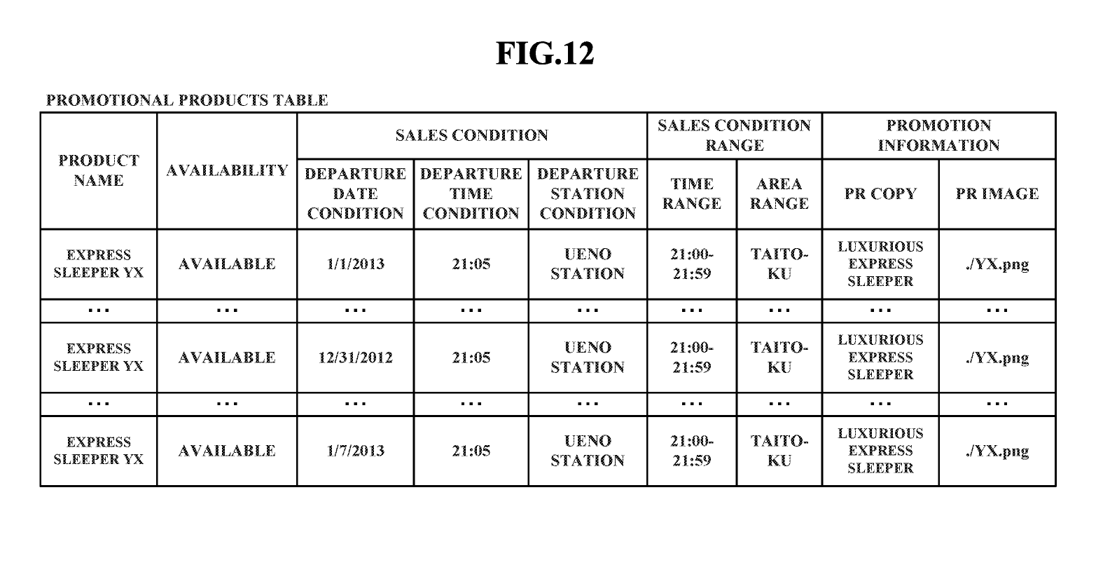

The information storage 190 stores a promotional products table as shown in FIG. 12. The promotional products table associates and saves multiple pieces of information presenting the name of a promotional product, information presenting whether the promotional product is available, information presenting the sales condition of the promotional product, information presenting the sales condition range of the promotional product, and information for promoting the sale of the promotional product (the promotion information, hereafter). The promotion information includes a PR (public relations) text and PR image of the promotional product.

Returning to FIG. 6, the search range acquirer 120, sale product searcher 130, promotional product searcher 140, creator 150, and outputter 160 will be described hereafter in sequence.

The search range acquirer 120 acquires from the LAN card 106 shown in FIG. 4 search condition data sent from the terminal device 210. The search range acquirer 120 further acquires from the area ranges table shown in FIG. 7 and the time ranges table shown in FIG. 9 the search range into which the search condition presented by the acquired search condition data is classified.

The sale product searcher 130 searches for a sales condition range matching the search range acquired by the search range acquirer 120, and searches the sale products table shown in FIG. 11 for a sale product sold under a condition classified into the found range.

The promotional product searcher 140 searches for a sales condition range of which the difference from the search range acquired by the search range acquirer 120 is equal to or smaller than a given difference, and searches the promotional products table shown in FIG. 12 for a promotional product sold under a condition classified into the found range.

The creator 150 creates a webpage posting the sale product found by the sale product searcher 130 and the promotional product found by the promotional product searcher 140 (the search results page, hereafter).

The outputter 160 outputs to the LAN card 106 shown in FIG. 4 the search results page created by the creator 150 with its destination set to the terminal device 210.

Returning to FIG. 5, the search procedure will be described hereafter.

As the LAN card 106 receives search condition data from the terminal device 210, the CPU 101 starts executing the search procedure.

As the execution of the search procedure starts, the search range acquirer 120 acquires the search condition data from the LAN card 106 (Step S01).

Then, the search range acquirer 120 acquires the search range into which the search condition presented by the acquired search condition data is classified (Step S02). This embodiment is described on the assumption that the search condition comprises a search date condition specifying “01/01/2013,” a search time condition specifying “20:15,” and a search station condition specifying “TOKYO STATION.” Therefore, the search range acquirer 120 designates “CHIYODA-KU” presented by information associated with information presenting “TOKYO STATION” in the area ranges table shown in FIG. 7 as the search area range into which the search station condition is classified. The search range acquirer 120 further designates the “20:00-20:59” presented by information associated with both information presenting “20:00,” which is earlier than “20:15,” and information presenting “20:59,” which is later than “20:15,” in the time ranges table shown in FIG. 9 as the search time range into which the search time condition is classified. Subsequently, the search range acquirer 120 designates the range comprising the search area range “CHIYODA-KU” and search time range “20:00-20:59” as the search range.

Subsequently, the sale product searcher 130 searches for a sales condition range matching the search range (Step S03). More specifically, the sale product searcher 130 searches the sale products table shown in FIG. 11 for a sales condition range presented by information associating information presenting the search area range “CHIYODA-KU” and information presenting the search time range “20:00-20:59” constituting the search range. Subsequently, using the sales condition range presented by the found information, the sale product searcher 130 searches for a sales condition range associated with a departure date condition specifying the date identical to the date “01/01/2013” specified by the search date condition and available.

Then, the sale product searcher 130 designates the sale product of the name associated with the found sales condition range in the sale products table as the found sale product (Step S04). More specifically, the sale product searcher 130 designates a ticket for “EXPRESS XX” departing from “TOKYO STATION” at “01/01/2013 20:02” and a ticket for “EXPRESS XY” departing from “TOKYO STATION” at “01/01/2013 20:45” associated with the departure date condition “01/01/2013”, time range “20:00-20:59,” and area range “CHIYODA-KU” as the found sale product.

Subsequently, the promotional product searcher 140 searches for a sales condition range of which difference from the search range is equal to or smaller than a given difference. In this embodiment, the sales condition ranges adjoining the search range are assumed to be the sales condition range of which the difference from the search range is equal to or smaller than a given difference (Step S05). More specifically, the promotional product searcher 140 acquires from the adjoining areas table shown in FIG. 8 an area range “TAITO-KU” adjoining the search area range “CHIYODA-KU” constituting the search range. Then, the promotional product searcher 140 acquires from the adjoining time ranges table shown in FIG. 10 time ranges “19:00-19:59” and “21:00-21:59” adjoining the search time range “20:00-20:59” constituting the search range. Subsequently, the promotional product searcher 140 searches the promotional products table shown in FIG. 12 for a sales condition range presented by information associating information presenting the adjoining area range “TAITO-KU” and adjoining time range “19:00-19:59,” and/or a sales condition range presented by information associating information presenting the adjoining area range “TAITO-KU” and adjoining time range “21:00-21:59”. Subsequently, using found sales condition range, the promotional product searcher 140 searches for a sales condition range associated with a departure date condition specifying the date identical to the date “01/01/2013” specified by the search date condition and available.

Then, the promotional product searcher 140 designates the promotional product of the name associated with the found sales condition range in the promotional products table as the found promotional product (Step S06). More specifically, the promotional product searcher 140 designates a ticket for “EXPRESS SLEEPER YX” departing from “UENO STATION” at “01/01/2013 21:05” associated with the area range “TAITO-KU” and time range “21:00-21:59” as the found promotional product.

Then, the creator 150 acquires information presenting the sales condition associated with information presenting the name of the found promotional product found by the promotional product searcher 140 and information presenting a PR copy and PR image. Then, the creator 150 creates promotion information of the found promotional product including the sales condition, text presenting the PR copy, and PR image of the found promotional product.

Subsequently, the creator 150 creates a webpage having the search results output screen as shown in FIG. 3 posting the found sale product found by the sale product searcher 130, found promotional product found by the promotional product searcher 140, and created promotion information (namely, a search results page) (Step S07).

The search results page has a found sale product display region PL displaying the found sale product and a found promotional product display region QL displaying the found promotional product. The names “EXPRESS XX” and “EXPRESS XY” of the tickets found by the sale product searcher 130 are displayed in the found sale product display region PL. Text presenting the sales condition that the train departs from “TOKYO STATION” at “01/01/2013 20:02” and a button linked to a webpage used for selling the ticket are displayed in association with the ticket name “EXPRESS XX.” With the user's one click on the button, the webpage used for selling the ticket for “EXPRESS XX” is displayed.

Similarly, text presenting the sales condition that the train departs from “TOKYO STATION” at “01/01/2013 20:45” and a button linked to a webpage used for selling the ticket are displayed in association with the ticket name “EXPRESS XY.”

In the found promotional product display region QL, the name “EXPRESS SLEEPER YX” of the ticket found by the promotional product searcher 140, a button BD linked to a webpage used for selling the ticket, and promotion information for promoting the sale of the ticket are displayed. The promotion information includes text CT presenting the sales condition that the train departs from “UENO STATION” at “01/01/2013 20:05” and a PR image PRP and PR copy text PRT advertising the ticket (or possibly the train).

After the Step S07, the outputter 160 outputs to the LAN card 106 shown in FIG. 4 the search results page created by the creator 150 with its destination set to the terminal device 210 (Step S08). Subsequently, the LAN card 106 sends the search results page to the destination. The terminal device 210 receives the search results page and displays the received page. Then, the outputter 160 ends the search procedure.

With the above configuration, the search device 100 outputs a search results page posting a promotional product sold under a condition classified into a range that does not match the search range but of which the difference from the search range is equal to or smaller than a given difference. Therefore, compared with the case of a webpage posting a promotional product sold under a condition classified into a range irrelevant to the search range being output, the user can easily accept the difference between the range into which the sales condition of the promotional product posted on the webpage is classified and the search range. Thus, the search device 100 can output information for promoting the sale of a product different from the search condition with less impaired convenience to the user.

Furthermore, with the above configuration, the search device 100 can search for a range of which the difference from the search range is equal to or smaller than a given difference and a promotional product sold under a condition classified into such a range without associating and prestoring a search range and a range of which the difference from the search range is equal to or smaller than a given difference. Therefore, the volume of information stored by the search device 100 can be reduced compared with the prior art.

Furthermore, with the above configuration, the search device 100 outputs a webpage positing promotion information including the sales condition of the found promotional product and promoting the sale of the promotional product. Therefore, the user can easily determine whether to purchase the product based on the sales condition included in the promotion information, which is more convenient to the user.

### Modified Embodiment 1 of Embodiment 1

In the above embodiment, the terminal device 210 shown in FIG. 1 displays the search condition input screen as shown in FIG. 2A, enters a search condition according to the user operation, and sends data presenting the search condition to the search device 100. Furthermore, the search range acquirer 120 of the search device 100 shown in FIG. 6 acquires from the information storage 190 the search range into which the search condition presented by the data received by the LAN card 106 shown in FIG. 4 from the terminal device 210 is classified. However, this is not restrictive. The terminal device 210 can display a search range input screen as shown in FIG. 2B, enters a search range according to the user operation, and sends data presenting the search range to the search device 100. Furthermore, the search range acquirer 120 of the search device 100 can acquire the data presenting the search range that are received by the LAN card 106 from the terminal device 210.

### Modified Embodiment 2 of Embodiment 1

In the above embodiment, the sales condition range comprising both the range adjoining the search area range and the range adjoining the search time range is designated as the sales condition range of which the difference from the search range is equal to or smaller than a given difference. However, this is not restrictive. The sales condition range comprising either one of the range adjoining the search area range and the range adjoining the search time range can be designated as the sales condition range of which the difference from the search range is equal to or smaller than a given difference.

### Modified Embodiment 3 of Embodiment 1

In the above embodiment, the search device 100 searches for a sales condition range adjoining the search range as the range of which the difference from the search range is equal to or smaller than a given difference. However, this is not restrictive. The search device 100 can search for ranges up to N ranges away from the search range as the range of which the difference from the search range is equal to or smaller than a given difference.

### Modified Embodiment 4 of Embodiment 1

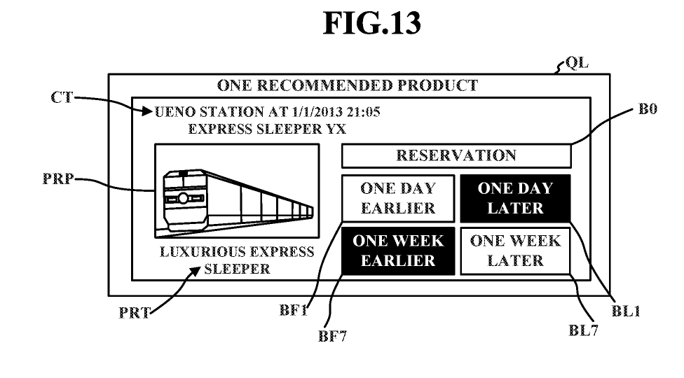

In Embodiment 1, the creator 150 of the search device 100 creates a search results page having the found sale product display region PL and found promotional product display region QL as shown in FIG. 3. In this modified embodiment, the creator 150 creates a search results page having the found sale product display region PL as shown in FIG. 3 and a found promotional product display region QL as shown in FIG. 13.

In the found promotional product display region QL shown in FIG. 13, the name “EXPRESS SLEEPER YX” of a ticket that is the found promotional product and information for promoting the sale such as a PR image PRP, PR copy PRT, and sales condition CT (namely the promotion information) are displayed. Furthermore, a button B0 having a notation “RESERVATION”, a button BF1 having a notation “ONE DAY EARLIER”, a button BL1 having a notation “ONE DAY LATER”, a button BF7 having a notation “ONE WEEK EARLIER”, and a button BL7 having a notation “ONE WEEK LATER” are displayed in the found promotional product display region QL.

The button B0 is linked to a webpage used for selling the ticket that is the found promotional product (the found promotional product sales page, hereafter).

The creator 150 searches the promotional products table shown in FIG. 12 for a promotional product associated with the ranges “TAITO-KU” and “21:00-21:59” identical to the sales condition range of the found promotional product, a departure date condition specifying “12/31/2012,” which is one day earlier than the departure date “1/1/2013” specified by the departure date condition of the found promotional product, and available (the promotional product with the one-day earlier departure condition, hereafter). Subsequently, the creator 150 links the sales page for selling the found promotional product with the one-day earlier departure condition to the button BF1 and enables the button BF1.

Similarly, the creator 150 searches for a promotional product associated with the ranges “TAITO-KU” and “21:00-21:59” identical to the sales condition range of the found promotional product, a departure date condition specifying “1/2/2013,” which is one day later than “1/1/2013,” and available, and determines that such a promotional product is not saved in the promotional products table. Subsequently, the creator 150 disables the button BL1.

Similarly, the creator 150 searches for a promotional product associated with “TAITO-KU” and “21:00-21:59”, a departure date condition specifying “12/25/2012,” which is seven days earlier than “1/1/2013,” and available, and determines that such a promotional product is not saved in the promotional products table. Subsequently, the creator 150 disables the button BF1.

The creator 150 searches for a promotional product associated with the ranges “TAITO-KU” and “21:00-21:59”, a departure date condition specifying “1/8/2013,” which is seven days later than “1/1/2013,” and available (the promotional product with the one-week later departure condition). Subsequently, the creator 150 links the sales page for selling the promotional product with the one-week later departure condition to the button BL7 and enables the button BL7.

With the above configuration, the search device 100 outputs a webpage displaying “ONE DAY EARLIER” and “ONE WEEK LATER” each of which is the difference between the departure date that is the time period in which the ticket that is a promotional product is used and the time period “1/1/2013” specified by the search condition with a linkage to a webpage used for purchasing the promotional product. Therefore, if the user accepts the difference, the user can easily purchase the promotional product on the webpage associated with the display presenting the difference, whereby the sale of the promotional product can be promoted.

With the above configuration, the search device 100 does not need to prestore the difference between the time period in which a promotional product is used and the time period specified by the search condition in association with a webpage used for purchasing the promotional product, whereby the volume of information stored by the search device 100 can be reduced compared with the prior art.

### Modified Embodiment 5 of Embodiment 1

In Modified Embodiment 4 of Embodiment 1, the creator 150 of the search device 100 creates a webpage having the found promotional product display region QL in which the button B0 having a notation “RESERVATION,” the button BF1 having a notation “ONE DAY EARLIER,” the button BL1 having a notation “ONE DAY LATER,” the button BF7 having a notation “ONE WEEK EARLIER,” and the button BL7 having a notation “ONE WEEK LATER” are displayed as shown in FIG. 13. Furthermore, in Modified Embodiment 4 of Embodiment 1, the enabled buttons among the buttons B0, BF1, BL1, BF7, and BL7 are each linked to a webpage used for selling the promotional product.

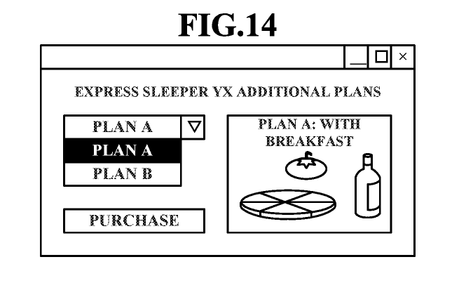

In this modified embodiment, the enabled buttons among the buttons B0, BF1, BL1, BF7, and BL7 are each linked to a webpage as shown in FIG. 14. The webpage in FIG. 14 is a webpage used for selecting a condition that can be added to the sales condition of the promotional product (an addable sales condition, hereafter) (the selection page, hereafter).

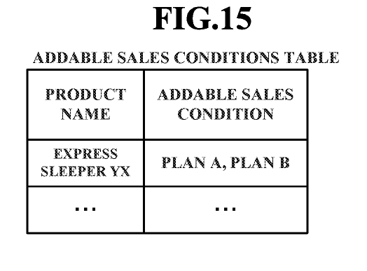

Therefore, the information storage 190 of the search device 100 stores an addable sales conditions table in which information presenting addable sales conditions are saved as shown in FIG. 15. The addable sales conditions table associates and saves multiple pieces of information presenting the name of a promotional product and information presenting multiple addable sales conditions.

This modified embodiment is described on the assumption that the addable sales condition includes a condition that the user can receive food and drink service in a dining car of the train he is on. This is not restrictive. For example, it is possible to include a condition that the seat can be changed to a larger one.

As a found promotional product is found by the promotional product searcher 140 shown in FIG. 6, the creator 150 acquires from the addable sales conditions table shown in FIG. 15 information presenting multiple addable sales conditions associated with information presenting the sales condition of the found promotional product. Then, the creator 150 creates a selection page having a list box displaying the multiple addable sales conditions presented by the acquired information as shown in FIG. 14.

Subsequently, the creator 150 creates a search results page having the found promotional product display region QL in which the buttons B0, BF1, BL1, BF7, and BL7 are displayed as shown in FIG. 13, and links the selection page to the enabled buttons among the buttons B0, BF1, BL1, BF7, and BL7.

Then, the outputter 160 outputs the search results page and selection page to the LAN card 106 shown in FIG. 4. The LAN card 106 sends the search results page and selection page to the terminal device 210.

Receiving the search results page and selection page from the search device 100, the terminal device 210 displays the received search results page. As the user conducts an operation on the inputter 211 to click an enabled button among the buttons B0, BF1, BL1, BF7, and BL7 posted on the search results page, the terminal device 210 displays the selection page linked to the clicked button.

Here, the explanation is made using the case in which the button BF1 displaying “ONE DAY EARLIER” is clicked.

If the user conducts an operation on the inputter 211 to select a desired addable sales condition among the multiple addable sales conditions displayed on the selection page, the terminal device 210 enters information presenting the selected addable sales condition. Then, the terminal device 210 sends to the search device 100 information specifying the promotional product with the departure condition earlier by one day than the departure date “1/1/2013” specified by the search condition and information presenting the selected addablel sales condition.

The search device 100 adds the addable sales condition presented by the received information to the sales condition of the promotional product with the one-day earlier departure condition identified by the received information, and sells to the user of the terminal device 210.

With the above configuration, the search device 100 displays the difference “ONE DAY EARLIER” between the departure date that is the time period in which the ticket that is a promotional product is used and the departure date “1/1/2013” specified by the search condition in association with the selection page used for adding a condition to the sales condition of the promotional product. Therefore, even if the user does not accept the difference, adding a condition the user desires to the sales condition makes the difference easily acceptable to the user, whereby the sale of the promotional product can be promoted.

### Modified Embodiment 6 of Embodiment 1

In Embodiment 1, the search device 100 outputs a search results page having a found sale product display region PL and a found promotional product display region QL and the terminal device 210 displays a single search results page having a found sale product display region PL and a found promotional product display region QL.

In this modified embodiment, the search device 100 outputs two webpages, a webpage having a found sale product display region PL and a webpage having a found promotional product display region QL. The terminal devices 210 and 220 receive a webpage having a found sale product display region PL and a webpage having a found promotional product display region QL and display these two webpages.

### Modified Embodiment 7 of Embodiment 1

In Modified Embodiment 6 of Embodiment 1, the terminal device 210 receives a webpage having a found sale product display region PL and a webpage having a found promotional product display region QL and displays these two webpages.

In this modified embodiment, receiving a webpage having a found sale product display region PL and a webpage having a found promotional product display region QL, the terminal device 210 first displays the webpage having a found sale product display region PL. Subsequently, as the cursor is moved from outside the found sale product display region PL to the inside thereof according to the user operation on the inputter 211, the terminal device 210 displays the webpage having a found promotional product display region QL.

### Modified Embodiment 8 of Embodiment 1

In Modified Embodiment 7 of Embodiment 1, receiving a webpage having a found sale product display region PL and a webpage having a found promotional product display region QL, the terminal device 210 first displays the webpage having a found sale product display region PL. Furthermore, in Modified Embodiment 7 of Embodiment 1, as the cursor display is moved from outside the found sale product display region PL to the inside thereof, the terminal device 210 displays the webpage having a found promotional product display region QL.

In this modified embodiment, the webpage having a found sale product display region PL has a button or text linked to a webpage having a found promotional product display region QL. Therefore, as the user conducts an operation on the inputter 211 to click the button or text after the webpage having a found sale product display region PL is displayed, the terminal device 210 displays the webpage having a found promotional product display region QL.

### Modified Embodiment 9 of Embodiment 1

In Embodiment 1, the sales condition range adjoining a search range is the sales condition range of which the difference from the search range is equal to or smaller than a given difference. In other words, in Embodiment 1, the sales condition range comprising the adjoining area range of the search area range and the adjoining time range of the search tome range is the sales condition range of which the difference from the search range is equal to or smaller than a given difference.

In this embodiment, the search device 100 associates and stores multiple pieces of information presenting an area range saved in the area ranges table shown in FIG. 7, information presenting a representative point in the area range, and information presenting the latitude and longitude of the representative point. The representative point can be a point where the busiest station locates among multiple stations in the area range or a point located at the center of the area range.

The search device 100 calculates the distance between the representative point of the search area range and the representative point of the area range of the sales condition using the latitudes and longitudes of the representative points.

Furthermore, the search device 100 associates and stores information presenting a time range saved in the time ranges table shown in FIG. 9 and information presenting a representative time of the time range. The representative time can be the start time or end time of the time range or the time dividing the time range in halves. The search device 100 calculates the absolute value of the difference between the representative time of the search time range and the representative time of the time range of the sales condition.

Subsequently, the search device 100 calculates the total value of the value obtained by multiplying the calculated distance between the representative points by a given first number and the value obtained by multiplying the absolute value of the difference between the representative times by a given second number, and designates the calculated value as the distance between the search range and sales condition range. The search device 100 determines that the difference between the search range and sales condition range is equal to or smaller than a given difference when the calculated distance between the ranges is equal to or smaller than a given threshold.

Moreover, preferable values of the first number and second number and the threshold to compare to the distance between the ranges can each be determined through experiment by a person of ordinary skill in the field.

### Embodiment 2

In Embodiment 1, the search device 100 searches a group of sale products for a product sold under a condition classified into the range matching the search range as a found sale product. Furthermore, the search device 100 searches a group of promotional products for a product sold under a condition classified into a range that does not match the search range but of which difference from the search range is equal to or smaller than a given difference as a found promotional product.

In Embodiment 1, the range of which the differences from the search range is equal to or smaller than a given difference is the sales condition range comprising both the range adjoining the search area range and the range adjoining the search time range.

In this embodiment, as in Embodiment 1, the search device 100 searches a group of sale products for a product sold under a condition classified into the range matching the search range as a found sale product. However, unlike Embodiment 1, the search device 100 designates a promotional product satisfying the following Condition 1 as a product sold under a condition falling within a range of which the difference from the search range is equal to or smaller than a given difference.

Condition 1: Departing from the destination station specified by the sales condition at the arrival date/time of a train specified by the sales condition of a ticket that is a promotional product, the user can travel to the departure station of the connecting train specified by the search condition before the departure date/time of the connecting train.

The search device 100 according to this embodiment has the same function and configuration as the search device 100 according to Embodiment 1; therefore, duplicate explanation with Embodiment 1 will be omitted.

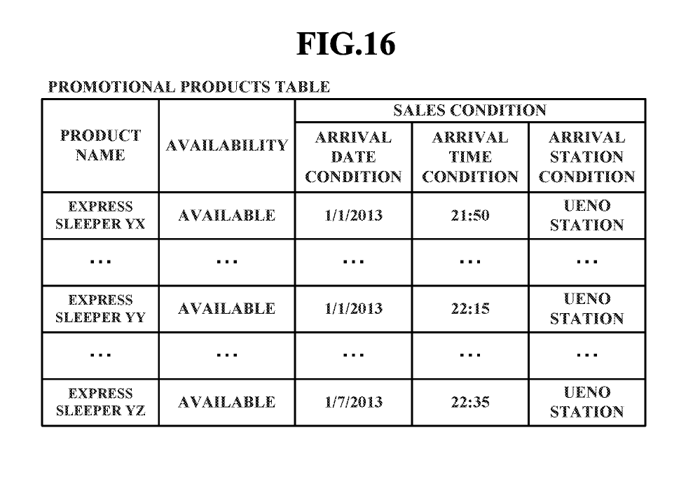

Therefore, the information storage 190 of the search device 100 stores a promotional products table shown in FIG. 16. The promotional products table associates and saves multiple pieces of information presenting the name of a promotional product, information presenting whether the promotional product is available, and information presenting the sales condition of the promotional product. The sales condition of the promotional product comprises an arrival date condition conditioning on the arrival date of a train, an arrival time condition conditioning on the arrival time of the train, and an arrival station condition conditioning on the arrival station of the train.

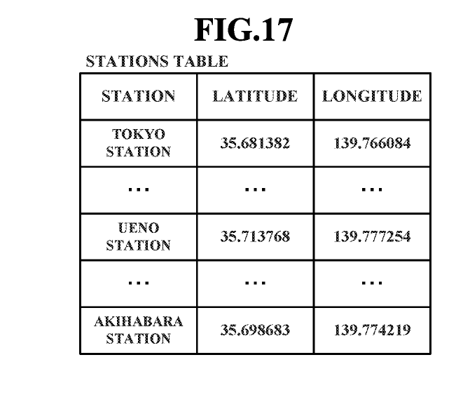

Furthermore, the information storage 190 of the search device 100 stores a stations table in which multiple pieces of information associating information presenting the mane of a station and information presenting the latitude and longitude of the station are saved as shown in FIG. 17. This is for the search device 100 to identify the latitudes and longitudes of stations in the stations table and calculate the distance between the stations using the identified latitudes and longitudes.

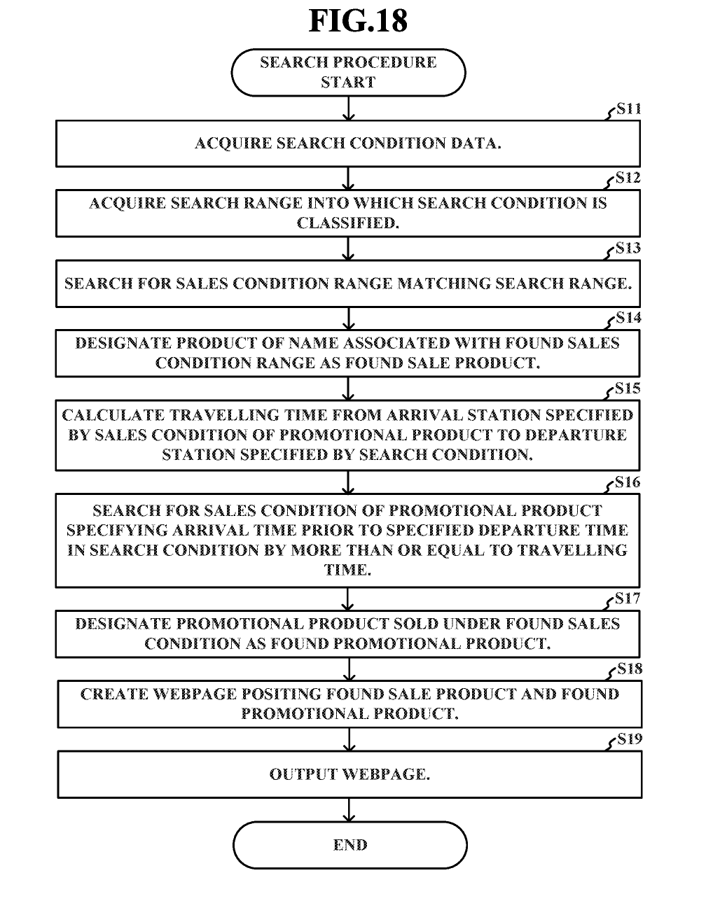

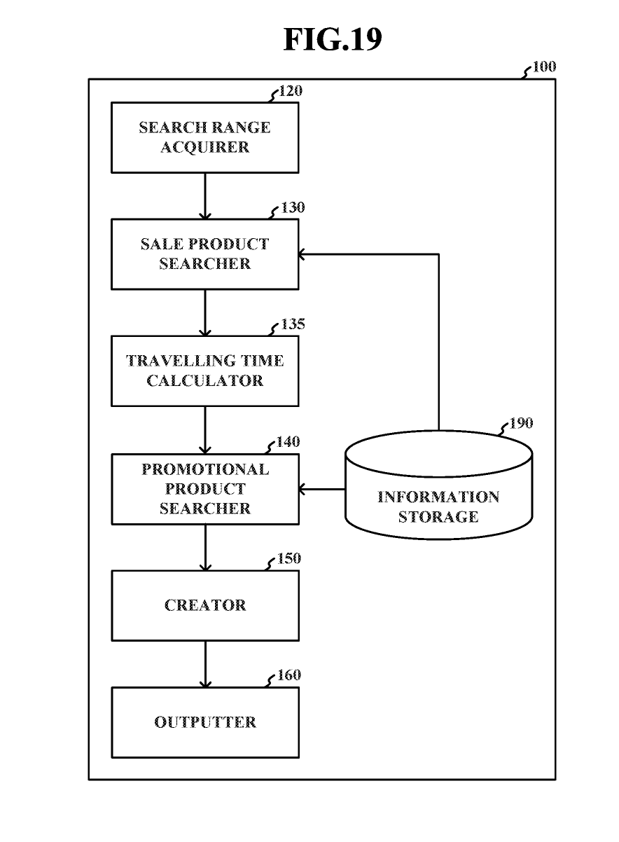

Executing the search procedure as shown in FIG. 18, the search device 100 according to Embodiment 2 functions as a traveling time calculator 135 as shown in FIG. 19 in addition to the search range acquirer 120, sale product searcher 130, promotional product searcher 140, creator 150, and outputter 160 shown in FIG. 6.

The travelling time calculator 135 calculates the traveling time required for the user to travel from an arrival station to a departure station for catching a connection train.

As the LAN card 106 receives search condition data from the terminal device 210, the search device 100 starts executing the search procedure shown in FIG. 18

As the execution of the search procedure starts, the search range acquirer 120 acquires the search condition data from the LAN card 106 (Step S11).

Then, the search range acquirer 120 acquires the search range into which the search condition presented by the acquired search condition data is classified (Step S12). This embodiment is described on the assumption that the search condition comprises a search departure date condition specifying a departure date “01/01/2013,” a search departure time condition specifying a departure time “20:15,” and a search departure station condition specifying a departure station “TOKYO STATION.” Therefore, the search range acquirer 120 designates the range comprising the search departure time range “20:00-20:59” and search departure area range “CHIYODA-KU” as the search range.

Subsequently, the sale product searcher 130 searches the sale products table shown in FIG. 11 for a sales condition range matching the search range (Step S13). Subsequently, using the sales condition range presented by the found information, the sale product searcher 130 searches for a sales condition range associated with a departure date condition specifying the date identical to the date “01/01/2013” specified by the search departure date condition and available. As a result, the sale product searcher 130 finds a ticket for “EXPRESS XX” departing from “TOKYO STATION” at “01/01/2013 20:02” and a ticket for “EXPRESS XY” departing from “TOKYO STATION” at “01/01/2013 20:45” as found sale products (Step S14).

Subsequently, the travelling time calculator 135 acquires from the promotional products table shown in FIG. 16 multiple pieces of information presenting the arrival station condition constituting the sales condition of a promotional product. Then, the travelling time calculator 135 searches the stations table shown in FIG. 17 for information presenting the latitude and longitude of each of multiple arrival stations specified by the arrival station condition. Subsequently, the travelling time calculator 135 identifies the departure station specified by the search departure station condition constituting the search condition and searches the stations table shown in FIG. 17 for information presenting the latitude and longitude of the departure station.

Then, the travelling time calculator 135 calculates, for each of the arrival stations acquired from the promotional products table, the distance between the arrival station and departure station based on the latitude and longitude of the arrival station and the latitude and longitude of the departure station specified by the search condition. Then, the travelling time calculator 135 calculates the user travelling time for each arrival station by dividing the calculated distance to the departure station by an average taxi travelling speed (Step S15). This is because of the assumption that the user travels from the arrival station to the departure station by taxi.

In this embodiment, the travelling time calculator 135 calculates the user travelling time by dividing the calculated distance from the arrival station to the departure station by an average taxi travelling speed. However, this is not restrictive. When the distance is larger than a given value, the travelling time calculator 135 can calculate the travelling time by dividing the distance from the arrival station to the departure station by an average aircraft travelling speed. Furthermore, when the distance is smaller than another given value, the travelling time can be calculated by dividing the distance from the arrival station to the departure station by an average human walking or cycling speed.

Subsequently, for each arrival station presented by information saved in the promotional products table, the promotional product searcher 140 searches for a sales condition specifying the date identical to the departure date specified by the search condition as the arrival date and specifying an arrival time prior to the departure time specified by the search condition by the travelling time calculated by the travelling time calculator 135 or more as the arrival time (Step S16).

Here, the promotional products table saves information presenting an arrival station “UENO STATION.” The departure date/time specified by the search condition is “1/1/2013 20:15” and the departure station specified by the search condition is “TOKYO STATION.” Assuming that the travelling time from Ueno Station to Tokyo Station calculated by the travelling time calculator 135 is “15 minutes,” the promotional product searcher 140 searches for a sales condition of arriving at “UENO STATION” at “1/1/2013 19:50,” which is earlier than the date/time “1/1/2013 20:00.” This is because the user can travel to “TOKYO STATION” by “1/1/2013 20:15” if he arrives at “UENO STATION” at “1/1/2013 19:50.”

Subsequently, the promotional product searcher 140 searches the promotional products table shown in FIG. 16 and finds a promotional product “EXPRESS SLEEPER YX” sold under the condition of arriving at “UENO STATION” at “1/1/2013 19:50” as a found promotional product (Step S17).

Then, the creator 150 creates a search results page posting the found sale product found by the sale product searcher 130 and the found promotional product found by the promotional product searcher 140 (Step S18). Subsequently, the outputter 160 outputs to the LAN card 106 shown in FIG. 4 the search results page created by the creator 150 with its destination set to the terminal device 210 (Step S19). Subsequently, the outputter 160 ends the execution of the search procedure.

### Modified Embodiment 1 of Embodiment 2

In this modified embodiment, the search device 100 designates a promotional product satisfying the following Condition 2 as a product sold under a condition falling within a range of which the difference from the search range is equal to or smaller than a given difference.

Condition 2: Starting from the arrival station specified by the search condition at the arrival date/time of a train specified by the search condition, the user can travel to the departure station of a connecting train specified by the sales condition of a ticket that is a promotional product before the departure date/time of the connecting train.

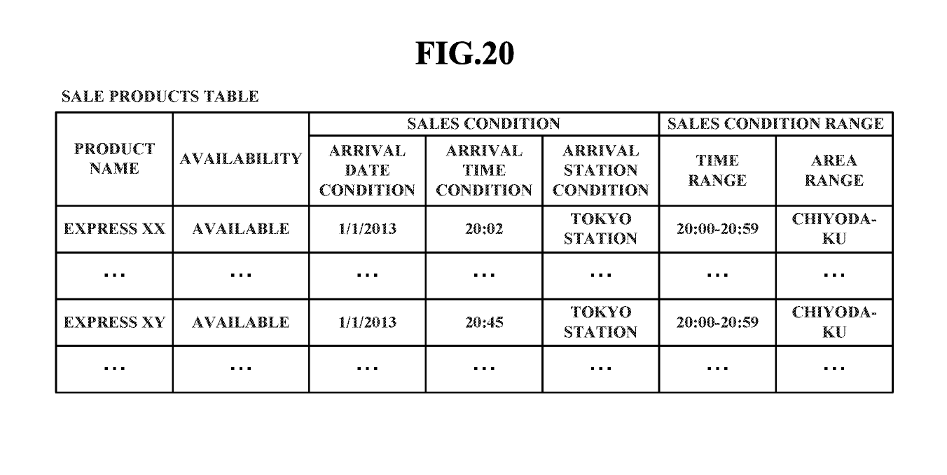

Therefore, the information storage 190 of the search device 100 stores a sale products table as shown in FIG. 20. The sale products table associates and saves multiple pieces of information presenting the name of a sale product, information presenting whether the sale product is available, information presenting the sales condition of the sale product, and information presenting the sales condition range of the sale product. The sales condition of a sale product comprises an arrival date condition conditioning on the arrival date of a train, an arrival time condition conditioning on the arrival time of the train, and an arrival station condition conditioning on the arrival station of the train.

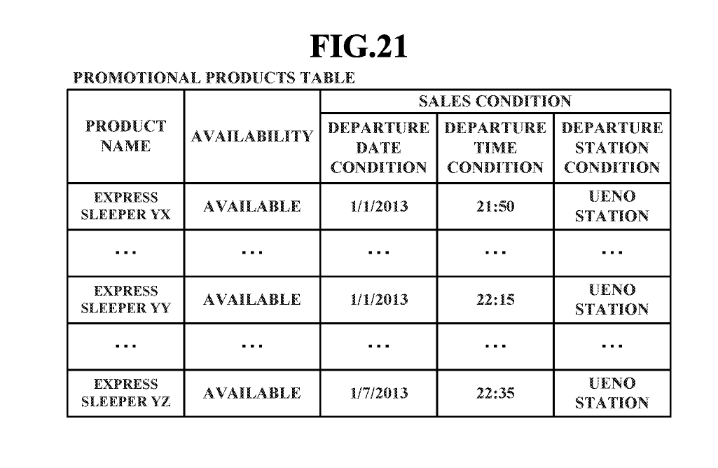

Furthermore, the information storage 190 stores a promotional products table as shown in FIG. 21. The promotional products table associates and saves multiple pieces of information presenting the name of a promotional product, information presenting whether the promotional product is available, and information presenting the sales condition of the promotional product. The sales condition of a promotional product comprises a departure date condition conditioning on the departure date of a train, a departure time condition conditioning on the departure time of the train, and a departure station condition conditioning on the departure station of the train.

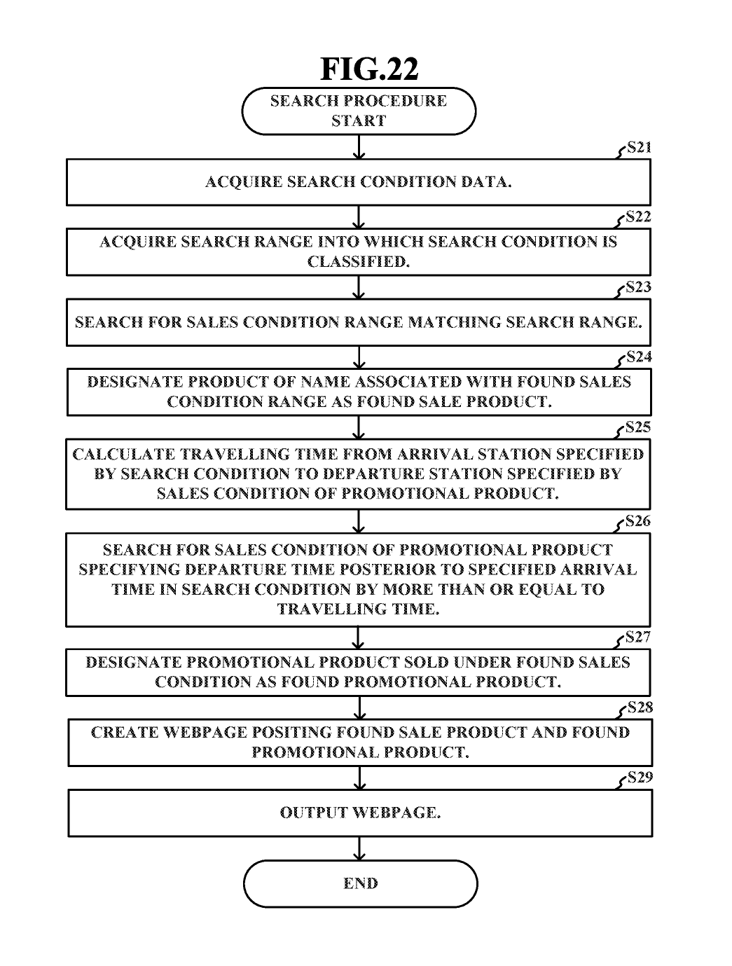

As the LAN card 106 receives search condition data from the terminal device 210, the search device 100 starts executing the search procedure as shown in FIG. 22.

As the execution of the search procedure starts, the search range acquirer 120 acquires the search condition data from the LAN card 106 (Step S21). In this modified embodiment, the search condition comprises a search arrival date condition specifying an arrival date, a search arrival time condition specifying an arrival time, and a search arrival station condition specifying an arrival station.

Then, the search range acquirer 120 acquires the search range into which the search condition presented by the acquired search condition data is classified (Step S22). Subsequently, the sale product searcher 130 searches the sale products table shown in FIG. 20 for a sales condition range matching the search range (Step S23). Subsequently, using the sales condition range presented by the found information, the sale product searcher 130 searches for a sale product associated with an arrival date condition specifying the date identical to the date specified by the search condition and available (Step S24).

When multiple sale products are found in the Step S24, the sale product searcher 130 selects one product representing the multiple sale products found. The product representing the multiple sale products can be a product of which the arrival time specified by the search condition is the latest or a product of which the station specified by the search condition is the busiest.

Subsequently, the travelling time calculator 135 acquires from the promotional products table shown in FIG. 21 information presenting the departure station condition constituting the sales condition of the promotional product. Then, the travelling time calculator 135 calculates the travelling time from the arrival station specified by the sales condition of the found or selected sale product for each departure station specified by the departure station condition (Step S25).

Subsequently, for each departure station presented by information saved in the promotional products table, the promotional product searcher 140 searches for a sales condition specifying the date identical to the arrival date specified by the search condition as the departure date and specifying a time later than the arrival time specified by the search condition by the travelling time calculated by the travelling time calculator 135 or more as the departure time (Step S26).

Subsequently, the promotional product searcher 140 searches the promotional products table shown in FIG. 21 for a promotional product sold under the found sales condition as a found promotional product (Step S27).

Then, the creator 150 creates a search results page posting the found sale product found by the sale product searcher 130 and the found promotional product found by the promotional product searcher 140 (Step S28). Subsequently, the outputter 160 outputs to the LAN card 106 shown in FIG. 4 the search results page created by the creator 150 with its destination set to the terminal device 210 (Step S29). Subsequently, the outputter 160 ends the execution of the search procedure.

With the above configuration, the search device 100 searches the group of promotional products for a ticket for a train departing from the station to which the user can travel by the departure date/time specified by the sales condition if the user starts travelling from the arrival station at the arrival date/time specified by the search condition for catching a connecting train. Therefore, the user can easily accept the difference between the range into which the sales condition of a promotional product is classified and the search range, whereby the sale of a product not matching the search condition can be promoted with less impaired convenience to the user.

With the above configuration, the search device 100 does not need to associate and prestore multiple sets of a combination of arrival date/time and arrival station specified by the search condition and a ticket for a train departing from the station to which the user can travel by the departure date/time specified by the sales condition if the user starts travelling from the arrival station at the arrival date/time specified by the search condition for catching a connecting train. Therefore, the volume of information stored by the search device 100 can be reduced compared to the prior art.

### Modified Embodiment 2 of Embodiment 2

In Embodiment 2, the product is a train ticket. Furthermore, in Embodiment 2, a ticket for a train arriving at an arrival station at a date/time that allows the user to travel to the departure station of a connecting train specified by the search condition before the departure date/time of the connecting train is searched for as a promotional product.

In this modified embodiment, the product is a hotel reservation ticket. In this modified embodiment, the search device 100 searches for a hotel reservation ticket sold under the condition that the user checks out at a date/time or in a time period that allows the user to travel to a hotel situated at the location specified by the search condition or located in the area specified by the search range before the check-in date/time specified by the search condition or the check-in time period specified by the search range as a promotional product. The hotel of the reservation ticket searched for as a promotional product can be an alliance or affiliate hotel that belongs to the same group as and has the same parent company as the hotel of a reservation ticket sold under a condition classified into the range matching the search range.

### Modified Embodiment 3 of Embodiment 2

In Modified Embodiment 1 of Embodiment 2, the search device 100 searches for a ticket for a train departing from a station at a date/time that allows the user to catch a connection train if the user leaves the arrival station specified by the search condition at the arrival date/time of the train specified by the search condition as a promotional product.

However, this is not restrictive. The search device 100 can search for a hotel reservation ticket sold under a condition specifying a check-in date/time or time period that allows the user to check in if the user starts travelling from the hotel situated at the location specified by the search condition or located in the area specified by the search range at the check-out date/time specified by the search condition or in check-out time period specified by the search range.

### Embodiment 3

In this embodiment, when a found promotional product is sold, the search device 100 calculates acceptability indicating how easy for the user to accept the difference between the search range and the sales condition range of the found promotional product based on the difference in sales place between the found promotional product and found sale product. This is because in the event that the difference between the search range and the sales condition range of a found promotional product is more difficult for the user to accept, the user does not purchase the found promotional product unless the sales price of the found promotional product is much lower than the sales price of a found sale product. Conversely, in the event that the difference between the search range and the sales condition range of a found promotional product is easily acceptable to the user, the user purchases the found promotional product even if the sales price of the found promotional product is close to the sales price of a found sale product. Here, higher levels of acceptability mean that the difference between the search range and the sales condition range of a found promotional product is easily acceptable to the user.

The search device 100 according to this embodiment has the same function and configuration as the search device 100 according to Embodiment 1; therefore, duplicate explanation with the Embodiment 1 will be omitted.

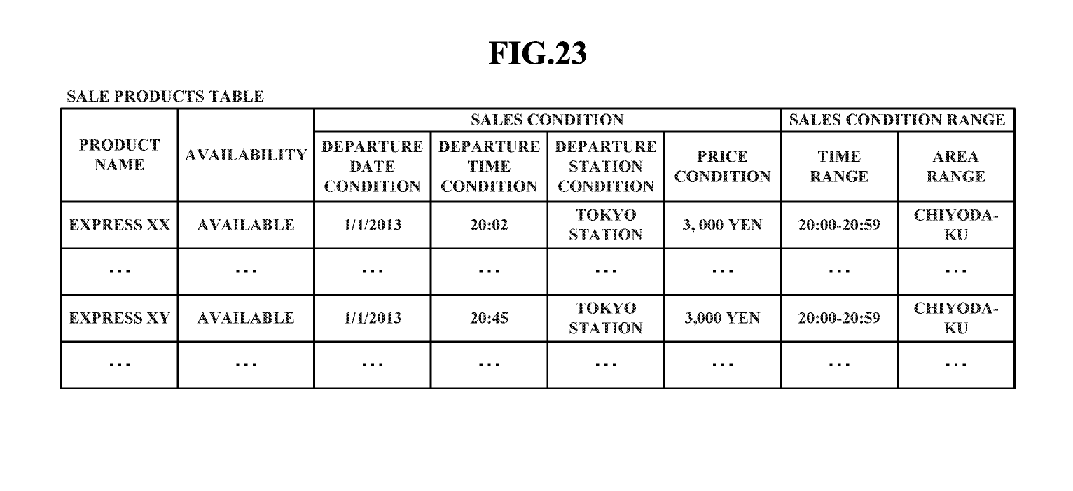

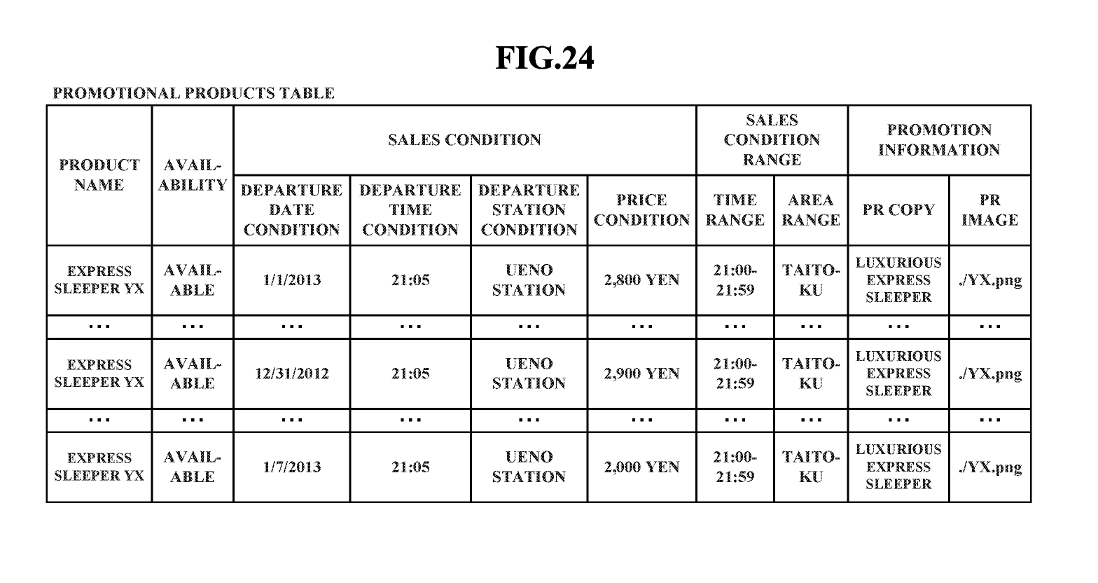

The search device 100 according to this embodiment stores a sale products table as shown in FIG. 23 for acquiring the sales price of a found sale product. Furthermore, the search device 100 stores a promotional products table as shown in FIG. 24 for acquiring the sales price of a found promotional product. The sales condition presented by information saved in the sale products table shown in FIG. 23 and the promotional products table shown in FIG. 24 includes a price condition specifying the sales price of a product.

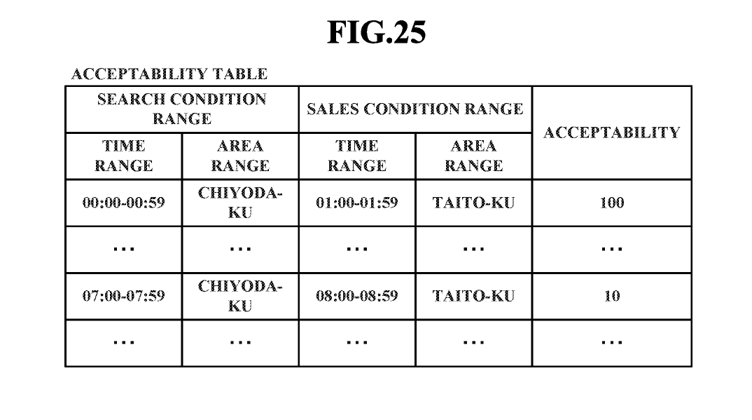

The search device 100 stores an acceptability table as shown in FIG. 25 as a table saving the acceptability calculated based on the difference in sales price between a found sale product and a found promotional product. The acceptability table associates and saves multiple pieces of information presenting a search condition range, information presenting a sales condition range, and information presenting the acceptability corresponding to the difference between the search condition range and sales condition range.

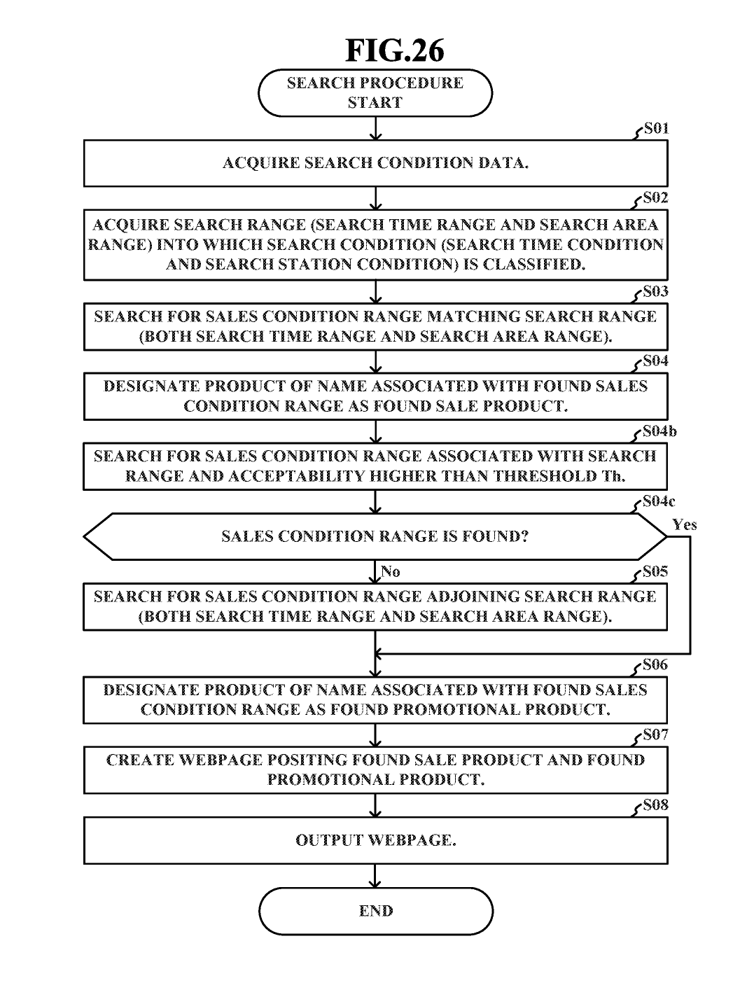

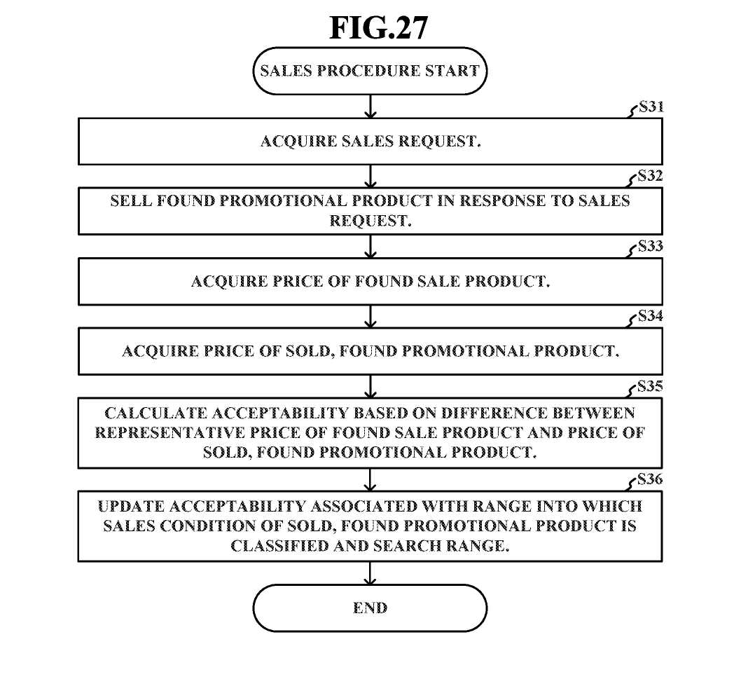

The search device 100 executes the search procedure shown in FIG. 26 and the sales procedure shown in FIG. 27. The search procedure in FIG. 26 is a procedure to search for a product based on the acceptability saved in the acceptability table. The sales procedure in FIG. 27 is a procedure to sell a product the user wishes to be sold among the found products.

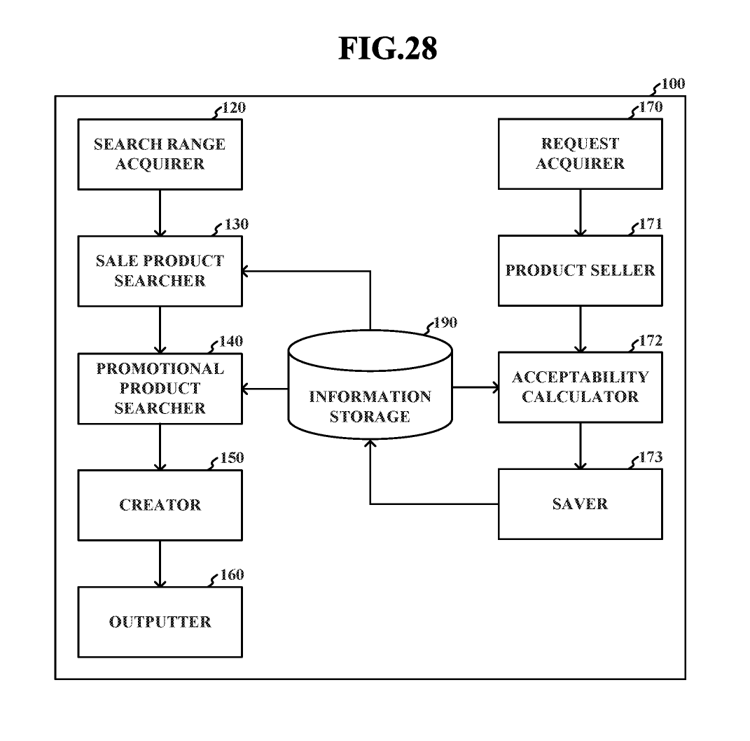

Executing the search procedure, the CPU 101 functions as a search range acquirer 120, sale product searcher 130, promotional product searcher 140, creator 150, and outputter 160 as shown in FIG. 28. Furthermore, the CPU 101 functions as an information storage 190 in cooperation with the hard disc 104 in FIG. 4. Furthermore, executing the sales procedure, the CPU 101 functions as a request acquirer 170, a product seller 171, an acceptability calculator 172, and a saver 173.

The search range acquirer 120, sale product searcher 130, promotional product searcher 140, creator 150, and outputter 160 are already described in Embodiment 1 and duplicate explanation is omitted. The information storage 190 stores the sale products table in FIG. 23, the promotional products table in FIG. 24, and the acceptability table in FIG. 25, which are already described.

The request acquirer 170 acquires a request asking for sale of a promotional product found by the promotional product searcher 140 (the sales request, hereafter).

The product seller 171 sells the product in response to the sales request. The acceptability calculator 172 calculates the acceptability of the user for the difference between the search range and the sales condition range of the promotional product asked for sale. The saver 173 saves in the information storage 190 the acceptability calculated by the acceptability calculator 172 in association with the search range and sales condition range.

Returning to FIG. 26, the search procedure executed by the search device 100 according to this embodiment will be described hereafter. As the LAN card 106 receives search condition data from the terminal device 210, the CPU 101 starts executing the search procedure shown in FIG. 26.

As the execution of the search procedure starts, the processing of the Steps S01 to S04 is executed. As a result, the search range acquirer 120 acquires the search condition data from the LAN card 106, the search range acquirer 120 acquires the search range into which the search condition is classified, and the sale product searcher 130 searches for a sales condition range matching the search range and designates the sale product of the name associated with the found sales condition range as a found sale product.

Then, the promotional product searcher 140 reads information presenting a threshold Th from the information storage 190 and searches the acceptability table in FIG. 25 for a sales condition range associated with the acceptability higher than the threshold Th and the search range as a range of which the difference from the search range is equal to or smaller than a given difference (Step S04b).

Then, the promotional product searcher 140 determines whether a sales condition range is found (Step S04c). At this point, if no sales condition range is found (Step S04c; No), the promotional product searcher 140 executes the processing of the Step S05 described in Embodiment 1. As a result, the promotional product searcher 140 searches for a range adjoining the search range as a range of which the difference from the search range is equal to or smaller than a given difference.

If the promotional product searcher 140 determines that a sales condition range is found in the Step S04c (Step S04c; Yes) or after the processing of the Step S05 is executed, the promotional product searcher 140 executes the processing of the Step S06. As a result, the promotional product searcher 140 searches for a promotional product sold under a condition classified into a range of which the difference from the search range is equal to or smaller than a given difference.

Subsequently, the creator 150 creates a search results page posting the found sale product found in the Step S04 and the found promotional product found in the Step S06 (Step S07) and then the outputter 160 outputs the search results page with its destination set to the terminal device 210 (Step S08). Subsequently, the execution of the search procedure ends.

Receiving the search results page, the terminal device 210 displays the received page. According to the operation of the user who viewed the search result page, the terminal device 210 enters a sales request including information identifying the product the user wishes to be sold among the found promotional products posted on the search results page. Then, the terminal device 210 sends the sales request to the search device 100.

As the LAN card 106 receives the sales request from the terminal device 210, the CPU 101 starts executing the sales procedure shown in FIG. 27. As the execution of the sales procedure starts, the request acquirer 170 acquires the sales request from the LAN card 106 (Step S31).

Then, the product seller 171 sells the found promotional product identified by information included in the sales request to the user (Step S32).

Subsequently, the acceptability calculator 172 determines whether there is one or are multiple found sale products found in the Step S04 in FIG. 26. At this point, if there is one found sale product, the acceptability calculator 172 acquires the sales price associated with the found sale product name from the sale products table shown in FIG. 23. On the other hand, if there are multiple found sale products, the acceptability calculator 172 selects a representative found sale product among the multiple found sale products, and acquires the sales price of the selected, found sale product from the sale products table (Step S33). Here, the representative found sale product can be a product of the highest price or a product of the lowest price, or a product of the highest sales figure. Furthermore, the acceptability calculator 172 can calculate the average price of the multiple found sale products.

Then, the acceptability calculator 172 acquires the charge for the sold, found promotional product from the promotional products table shown in FIG. 24 (Step S34).

Subsequently, the acceptability calculator 172 calculates the difference between the acquired charge for the found promotional product and the acquired sales price of the found sale product, and calculates the acceptability based on the calculated difference (Step S35).

The acceptability calculator 172 calculates a lower level of acceptability as the calculated difference is larger. This is because in the event that the difference between the search range and the sales condition range of the found promotional product is difficult for the user to accept, the found promotional product is not purchased unless the sales price of the found promotional product is significantly lower than the sales price of the found sale product.

Conversely, the acceptability calculator 172 calculates a higher level of acceptability as the calculated difference is smaller. This is because in the event that the difference between the search range and the sales condition range of the found promotional product is easily acceptable to the user, the found promotional product is purchased even if the difference from the sales price of the found sale product is small.

Subsequently, the saver 173 updates the information saved in the acceptability table in FIG. 25 with information presenting the acceptability calculated by the acceptability calculator 172 in association with the search range and the sales condition range of the purchased, found promotional product (Step S36). The updated information is referred to in the Step S04b of the search procedure shown in FIG. 26. Subsequently, the saver 173 ends the execution of the search procedure.

With the above configuration, the search device 100 can calculate the acceptability presenting how easy for the user to accept the difference between the search range and sales condition range based the difference in sales price between the sale product sold under a condition classified into the range matching the search range and the promotional product sold under a condition classified into a sales condition range not matching the search range.

With the above configuration, the search device 100 outputs a webpage posting the promotional product sold under a condition classified into a sales condition range of which the calculated acceptability is higher than a threshold Th. Therefore, the user can easily accept the difference between the sales condition range of the promotional product posted on the webpage and the search range, whereby the search device 100 can promote the sale of the product different from the search condition with less impaired convenience to the user.

Moreover, preferable values of the threshold Th to compare with the acceptability can be determined by a person of ordinary skill in the field through experiment. The threshold Th can be set to different values on the basis of user or on the basis of product.

Embodiments 1 to 3 and their modified embodiments can be combined with each other. Needless to say, the search device 100 comprising the configuration for realizing the functions according to any of Embodiments 1 to 3 and their modified embodiments can be provided. Moreover, a system configured by multiple devices and overall comprising the configuration for realizing the functions according to any of Embodiments 1 to 3 and their modified embodiments can be provided as well.

Needless to say, the search device 100 preliminary comprising the configuration for realizing the functions according to any of Embodiments 1 to 3 and their modified embodiments can be provided. Moreover, an existing search device 100 can be made to function as the search device 100 according to any of Embodiments 1 to 3 and their modified embodiments by application of the program. In other words, an existing search device 100 can be made to function as the search device 100 according to any of Embodiments 1 to 3 and their modified embodiments by application of the program for realizing the functional configuration of the search device 100 exemplified by any of Embodiments 1 to 3 and their modified embodiments in a manner that a computer (CPU or the like) controlling an existing transmission device can execute the program.

The program can be distributed by any method and, for example, saved and distributed on a non-transitory recording medium such as a memory card, CD-ROM, or DVD-ROM, or distributed via a communication medium such as the Internet. Moreover, the method according to the present disclosure can be implemented using the search device 100 according to any of Embodiments 1 and 2 and their modified embodiments.

The foregoing describes some example embodiments for explanatory purposes. Although the foregoing discussion has presented specific embodiments, persons skilled in the art will recognize that changes may be made in form and detail without departing from the broader spirit and scope of the invention.

Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

### REFERENCE SIGNS LIST

10 Communication network
100 Search device
101 CPU
102 ROM
103 RAM
104 Hard disc
105 Media controller
106 LAN card
107 Video card
108 LCD
109 Keyboard
110 Speaker
111 Touch pad
120 Search range acquirer
130 Sale product searcher
135 Travelling time calculator
140 Promotional product searcher
150 Creator
160 Outputter
170 Request acquirer
171 Product seller
172 Acceptability calculator
173 Saver
190 Information storage
210, 220 Terminal device
211, 221 Inputter
219, 229 display

1. A search device for searching for a product, comprising:
search range acquirer to acquire a search range in which a search condition of a product is classified;
sale product searcher to search for a product sold under a condition classified into a range matching the acquired search range;
promotional product searcher to search a group of promotional products undergoing sales promotion for a product sold under a condition classified into a range that does not match the search range but of which a difference from the search range is equal to or smaller than a given difference; and
outputter to output a webpage posting a found sale product that is the product found by the sale product searcher and a found promotional product that is the promotional product found by the promotional product searcher, or outputting a webpage positing the found sale product and a webpage posting the found promotional product.

2. The search device according to claim 1, wherein
the webpage posting the found sale product and the found promotional product and the webpage posting the found promotional product post promotion information including the sales condition of the found promotional product and promoting the sale of the found promotional product.

3. The search device according to claim 2, wherein
the webpage posting the found sale product and the found promotional product and the webpage posting the found promotional product each post an advertisement of the found promotional product as the promotion information.

4. The search device according to claim 3, wherein
the search condition includes a period-of-use specification condition specifying a time period in which the searched product is used,
the webpage posting the found promotional product includes one or more display items presenting a difference between a time period in which the found promotional product is used and the time period specified by the period-of-use specification condition, and
the one or multiple display items presenting the difference are associated with a webpage used for purchasing the found promotional product sold under the condition having the difference.

5. The search device according to claim 3, wherein
the search condition includes a period-of-use specification condition specifying a time period in which the searched product is used,
the webpage posting the found promotional product includes one or more display items presenting a difference between a time period in which the found promotional product is used and the time period specified by the period-of-use specification condition, and
the one or multiple display items presenting the difference are associated with a webpage used for adding a condition to the sales condition of the found promotional product having the difference.

6. The search device according to claim 1, wherein
the search condition of a product includes a start date/time specification condition specifying a date/time when the user purchasing the product starts using the product and a start place specification condition specifying a place where the user starts using the product,
travelling time calculator to calculate the traveling time required for the user to travel from a place where use of the promotional product ends to the place specified by the start place specification condition is further provided, and
the promotional product searcher searches promotional products sold under a condition classified into a range not matching the search range for a product sold under the condition that the use ends at a place different from the place specified by the start place specification condition and under the condition that the use ends at a date/time prior to the date/time specified by the start date/time specification condition by more than or equal to the traveling time as the product sold under the condition classified into the range of which difference from the search range is equal to or smaller than the given difference.

7. The search device according to claim 1, wherein
the search condition of a product includes an end date/time specification condition specifying a date/time when the user having purchased the product ends using the product and an end place specification condition specifying a place where the user ends use of the product,
travelling time calculator to calculate the traveling time required for the user to travel from the place specified by the end place specification condition to a place where use of the promotional product starts is further provided, and
the promotional product searcher searches promotional products sold under a condition classified into a range not matching the search range for a product sold under the condition that the use starts at a place different from the place specified by the end place specification condition and under the condition that the use starts at a date/time posterior to the date/time specified by the end date/time specification condition by more than or equal to the traveling time as the product sold under the condition classified into the range of which difference from the search range is equal to or smaller than the given difference.

8. The search device according to claim 1, further comprising:
request acquirer to acquire a sales request with the promotional product;
acceptability calculator to calculate the acceptability presenting how easy for the user to accept a difference between the range into which the sales condition of the promotional product is classified and the search range based on a difference in price between the promotional product sold in response to the sales request and the sale product; and
saver to save the calculated acceptability in a storage in association with the range into which the sales condition of the promotional product is classified and the search range,
wherein the promotional product searcher searches the group of products for a promotional product using the range associated with the acceptability higher than a given threshold and the search range as the range of which the difference from the search range is equal to or smaller than the given difference.

9. (canceled)

10. A computer-readable non-transitory recording medium on which a program for searching for a product is recorded, wherein the program allows a computer to function as:
search range acquirer to acquire a search range in which a search condition of a product is classified;
sale product searcher to search for a product sold under a condition classified into a range matching the acquired search range;
promotional product searcher to search a group of promotional products undergoing sales promotion for a product sold under a condition classified into a range that does not match the search range but of which a difference from the search range is equal to or smaller than a given difference; and
outputter to output a webpage posting a found sale product that is the product found by the sale product searcher and a found promotional product that is the promotional product found by the promotional product searcher, or outputting a webpage positing the found sale product and a webpage posting the found promotional product.

11. A method for searching for a product, comprising:
a search range acquisition step of acquiring a search range in which a search condition of a product is classified;
a sale product search step of searching for a product sold under a condition classified into a range matching the acquired search range;
a promotional product search step of searching a group of promotional products undergoing sales promotion for a product sold under a condition classified into a range that does not match the search range but of which a difference from the search range is equal to or smaller than a given difference; and
an output step of outputting a webpage posting a found sale product that is the product found by the sale product searcher and a found promotional product that is the promotional product found by the promotional product searcher, or outputting a webpage positing the found sale product and a webpage posting the found promotional product.
